(19) United States
(12) Patent Application Publication
(10) Pub. No.: US 2026/0270068 A1
(43) Pub. Date: Sep. 10, 2026

(54) AUTHENTICATION CIRCUIT

(71) Applicant: Benjamin Firooz Ghassabian, Toulon (FR)

(72) Inventor: Benjamin Firooz Ghassabian, Toulon (FR)

(21) Appl. No.: 19/165,584

(22) PCT Filed: Mar. 25, 2024
(86) PCT No.: PCT/IB2024/000116

§ 371 Date: Sep. 16, 2025

Related U.S. Application Data
(60) Provisional application No. 63/455,357, filed on Mar. 29, 2023.
(60) Provisional application No. 63/456,689, filed on Apr. 3, 2023.
(60) Provisional application No. 63/521,942, filed on Jun. 20, 2023.
(60) Provisional application No. 63/540,564, filed on Sep. 26, 2023.
(60) Provisional application No. 63/602,635, filed on Nov. 26, 2023.
(60) Provisional application No. 63/624,955, filed on Jan. 25, 2024.

(51) Int. Cl. H04L 9/32

(52) U.S. Cl. CPC H04L 9/3226

(57) ABSTRACT

An authentication system comprising an account within an account server, said account being protected by a password. The system further comprising a first communication device, a second communication device and a controlling server controlling a communication between the first device and the second device. Upon receiving, by the account server, a login request from said first device for accessing said account: (a) an encrypted random code is transmitted from the account server, to the second device, and (b) a corresponding decryption key is transmitted from the account server to the first device, wherein upon receiving said encrypted code by the second device and getting authorization for transmitting the encrypted code by the second device to the first device, said encrypted code is transmitted from the second device to the first device, and wherein upon receiving, by the first device, said encrypted code from said second device, said encrypted code is decrypted using said decryption key, and wherein the authentication system further includes a memory medium, separately from the first and the second devices, wherein said medium included a username required for logging into said account.

### FIELD OF THE INVENTION

This application claims priority under 35 USC .sctn.119(e) to U.S. Provisional Patent Application Ser. No. 63/455,357, filed on 29 Mar. 2023, U.S. Provisional Patent Application Ser. No. 63/456,689, filed on 3 Apr. 2023, U.S. Provisional Patent Application Ser. No. 63/521,942, filed on 20 Jun. 2023, U.S. Provisional Patent Application Ser. No. 63/540,564, filed on 26 Sep. 2023, U.S. Provisional Patent Application Ser. No. 63/602,635, filed on 26 Nov. 2023 and Provisional Patent Application Ser. No. 63/624,955, filed on 25 Jan. 2024, the entire contents of which is hereby incorporated by reference.

The following explains several embodiments with reference to the drawings. Each embodiment may have a portion corresponding to that of a precedent embodiment; such a portion is assigned with an identical reference number so as to omit overlapped explanation. When only a portion of the configuration of each embodiment is explained, the other portions of the configuration may adopt those of the precedent embodiment previously explained. Partial combination between the embodiments may be possible with respect to not only a portion which is explicitly described in each embodiment, but also a portion which is not explicitly described.

This patent application is mainly related to solving the major problem of the communication market, which is how to execute a highly secured log-in process, without using a password, for entering into a (e.g. existing) protected account within/controlled-by a local computer and/or within/controlled-by a remote (e.g., in the/a cloud) virtual and/or physical computing device (e.g., a server of a bank, a server of an insurance company, a healthcare website, an online shopping website, an online payment website such as PayPal, or within any other software requiring authentication of an identification, etc.) in a highly secured manner. Such server may, herein, be referred to as an “account server”. This patent application also is related to systems for executing protected functions without the use passwords.

### BACKGROUND OF THE INVENTION

A virtual content (e.g. data, software, etc.) can be locally located/stored within a computing device (e.g. PC, smartphone, etc.) or it may be remotely located/stored on/in a server. Some virtual contents are open to the public (e.g., herein may be referred to as “public content”), meaning that every person can access them without restriction (e.g., without requiring/using a password). On the other hand, some virtual contents are (e.g., password) protected, meaning that access to said contents is restricted to authorized people (e.g., herein may be referred to as “protected content”, “protected account”, “password protected account”, etc.). To access a protected account a user, generally, must/may-be required-to provide some/a predefined identification information (e.g., herein may be referred to as “user's ID”/“username”, etc.) to the server containing/holding said protected account. For simplifying the specification of this patent application, a computing device and/or a server having/holding a (e.g., one or more) protected account may herein be referred to as an “account server”.

Passwords are (e.g., frequency required and) used frequently for accessing protected contents. Users are often creating a different/new password for (e.g., creating and then) accessing a different/new protected content stored locally within a user's device and/or remotely within an account server.

Usually, a user creates a different password for accessing a different protected account. As such, a user may have one or more lists of tens or even hundreds of different passwords for tens or hundreds of protected accounts.

Many times a user does not have an access to a password (list) because it is out of the reach of the user at a specific time. For example, a (list of) password/s stored within a user's computing device and/or an accessory (e.g., a laptop, a smartphone, a tablet, a memory stick, etc.) or printed on paper, main remain at his/her home while the user is outside the home and, therefore, cannot connect to a protected account within an account server.

The above-explained reasons and more, makes the procedure of logging in to a protected account within a server, cumbersome, frustrating, time consuming and in some cases impossible. For logging in to a protected account, a user usually must look for a corresponding password within his/her device or within or on a paper where he usually stores or writes his/her (e.g. list of) passwords for saving them. Carrying a list of passwords one a computing device or on a paper is risky because it may be lost, stolen, being hacked by hackers or viewed accidentally to others.

In order to protect an account within an account server from being open/accessible to the general public and in order to restrict the access to said content to an (e.g., one or more) authorized person (e.g., only), a (e.g., one or more) (standard) access control system have been put in place in the industry. Said/an access control system usually consists of requires two steps:
Step 1: A Sign-in (e.g., registration) procedure for creating an access control system (e.g., to protect a corresponding user's account from being accessed by unauthorized people) requiring some information (e.g., such an identification keyword (e.g., a username), a password, user's telephone number, an email address, etc.) to be provided (e.g., by the user) to the corresponding account server. This step, is generally a mandatory step before/for being able to access/log in later to said account; and
Step 2: A log in (“log in”) procedure (e.g., for successfully bypassing/going through said access control system and accessing (e.g., logging into”) said (protected) account (e.g., for a user that has previously executed the sign-in procedure);

In step 1, a sign-in interface (e.g., a sign-in interface may herein be referred as to a “sign-in webpage”, or vise versa) is presented to a user on a screen of a computing device by a corresponding protecting account server. A user is generally required to provide a number/plurality of identification information, such as an identifying text (e.g., user's social security number. Herein may be referred to as user's ID), etc. (e.g., herein may be referred to as “Username”). In addition, the user is generally required to create and provide an arbitrary/desired password through said interface to the protecting account server. In some cases such a as for accessing an online bank account of a user, some of the user's account information such as a (e.g., his/her) username may be defined by the account server controlling said account (e.g., the bank).

In addition to the above, during a sign-in procedure, the user may also be required to provide additional information such as a contact information (e.g. telephone number (e.g., of a user's device), an email address, etc.) to which the protecting account server may send an information (e.g., herein may be referred to as a “security code”) during a log-in attempt (e.g., initiated by the user). In addition to the above, the user is usually required to define and provide a password for the (e.g., his/her) account within the account server.

The information provided by user during the sign-in procedure, is then stored (e.g., in a database) within a memory of a/the account server.

Step 2, is processed every time said user desires to access said protected account. For accessing the protected account, a log-in interface (e.g., a login interface may herein be referred as to a “login webpage”, or vise versa) is presented by the protected account server to a user on a screen of a computing device. A user is usually required to provide at least some of the information, including the password, that he/she has been provided (e.g., earlier) through/during the sign-in procedure. Upon providing the required information, an authentication software/procedure is executed (e.g., in the account server) to validate the authenticity of the information provided by the user. Upon validation, the user is given access (e.g., by the account server) to the protected content.

### SUMMARY OF THE INVENTION

The current invention is related to a system for securely accessing a (e.g., password) protected account without using a/the password. For such purpose, an authentication system/procedure comprising a circuit of plurality of devices communicating with each other (e.g., herein may be referred to as “authentication circuit”) is considered/used. Said system may preferably include an application for controlling the communication between said devices (e.g., herein may be referred to as “controlling application”).

An authentication circuit may preferably include an account server having at least one protected account, and generally at least two devices: a) a first communication device (e.g., herein may be referred to as, a “main device”) used for accessing (e.g. for logging in to) said/a protected account, b) and at least a second communication device (e.g., herein may be referred to as, an “intermediate device”) to which said account server may/will send a (e.g., an encrypted) security code during a/the log-in procedure (e.g., as described before). Note that, in accordance with the current invention, (e.g., in addition to a contact information (e.g., a/the telephone number) of the main device provided by the user during a corresponding sign-in procedure) a/the contact information (e.g., the telephone number) of said/a intermediate device is preferably also required by a corresponding account server (e.g., and must-be/is-preferably provided by the user) during a/the corresponding sign-in/(e.g., new) account registration procedure.

It is understood that, depending on to which protected account a user desires to access at a different instance, an account server within a/said authentication circuit may vary. As an example, when a user attempts to access his/her bank account within the server of a first bank, the account server within the corresponding authentication circuit will preferably be the account server of said first bank, and when a user attempts to access to his/her bank account within a second bank, the account server within said corresponding authentication circuit will preferably be the account server of said second bank.

Accordingly, as an example, when a user attempts to access his/her account within an online shopping store, the account server within the corresponding authentication circuit will preferably be the account server of said online shopping store.

An aspect of the invention is related to an authentication system using a serial communication network for accessing a protected account within/related-to an account server.

An aspect of the invention is related to an authentication system using a parallel communication network for accessing a protected account within/related-to an account server.

An aspect of the invention is related to an authentication system using a specific communication network for accessing a protected account within/related-to an account server.

An aspect of the invention is related to an authentication system using a serial communication network for automatically accessing a protected account within/related-to an account server, upon accomplishment a first condition.

An aspect of the invention is related to an authentication circuit comprising a Ntag containing a user's identification information/number.

An aspect of the invention is related to an authentication system using a serial communication network for automatically accessing a protected account within/related-to an account server, upon accomplishment a second condition.

An aspect of the invention is related to using an authentication circuit for executing a protected software.

An aspect of the invention is related to using an authentication circuit for executing a function.

An aspect of the invention is related to using an authentication circuit for executing a physical function.

As mentioned, the current patent application is related to systems for establishing a highly secured log-in procedure for accessing a (e.g., an existing) protected account in a (e.g. remote, local) account server without using a password (e.g., such systems may herein be referred to as “authentication system”, “authentication procedure”, “authentication circuit”, etc.)

An aspect of the current patent application is related to systems for executing a (e.g., a password) protected (e.g., virtual and/or physical) function without the need of a password.

It is important to note that before using an authentication system of the invention for accessing a protected account within an account server, the/a condition for accessing said protected account must have been defined/created (e.g., in advance) preferably through a sign-in procedure.

### BRIEF DESCRIPTION OF DRAWINGS

FIG. 1A shows a system of authentication for logging in to a protected account within an account server without the need of using a password, in accordance with an exemplary embodiment of the invention;

FIG. 1B shows a system for preventing a user to access a protected account within an account server (e.g., without using a password), in accordance with an exemplary embodiment of the invention;

FIG. 1C shows a system for preventing a user to access a protected account within an account server (e.g., without using a password), in accordance with an exemplary embodiment of the invention;

FIG. 2A shows a system of authentication for logging in to a protected account within an account server by using multiple devices, without the need using a password, in accordance with an exemplary embodiment of the invention;

FIGS. 2B-2C show two systems for preventing to logging in to a protected account within an account server without the need of using a password by using multiple devices, in accordance with an exemplary embodiment of the invention;

FIG. 3A shows a system for logging in to a protected account within an account server without the need of using a password by using multiple devices, in accordance with an exemplary embodiment of the invention;

FIG. 3B shows a system for preventing to logging in to a protected account within an account server without the need of using a password by using multiple devices, and a method of bypassing the prevention, in accordance with an exemplary embodiment of the invention;

FIG. 4A shows a system for logging in to a protected account within an account server without the need of using a password by using multiple devices, in accordance with an exemplary embodiment of the invention;

FIG. 4B shows a system for preventing to logging in to a protected account within an account server without the need of using a password by using multiple devices, in accordance with an exemplary embodiment of the invention;

FIG. 5A shows a system for logging in to a protected account within an account server without the need of using a password by using multiple devices, in accordance with an exemplary embodiment of the invention;

FIG. 5B shows a system for preventing to logging in to a protected account within an account server without the need of using a password by using multiple devices, in accordance with an exemplary embodiment of the invention;

FIGS. 6A to 6I, show exemplary controlling tables used by an application controlling different authentication procedures, in accordance with different embodiments of the invention;

FIG. 6J, shows an exemplary account server including a controlling table used by the controlling applications of authentication procedures, in accordance with a different embodiment of the invention;

FIG. 6K, shows an exemplary authentication circuit of the invention in accordance with an exemplary embodiment of the invention;

FIGS. 6L-6M, show an exemplary authentication circuit of the invention in accordance with an exemplary embodiment of the invention;

FIGS. 7A-7C, show exemplary authentication procedures for online payment, in accordance with a different embodiment of the invention;

FIGS. 8-8C, show some aspects of using a NFC tag, having a user identification number, in the authentication procedure of the invention, in accordance with different embodiments of the invention;

FIG. 8D, shows an aspect of the invention using a credit/debit card having a NFC tag/chip, having a user identification number, in an authentication procedure of the invention, in accordance with different embodiments of the invention;

FIG. 8E, shows an aspect of an authentication procedure of the invention, preferably, used for accessing an (e.g., online) account having a low-sensitive security level, in accordance with different embodiments of the invention;

FIG. 8F, shows a table of a controlling account including a parameter regarding a Ntag used with the authentication circuit of the invention, in accordance with an embodiment of the invention;

### DETAILED DESCRIPTION OF THE INVENTION

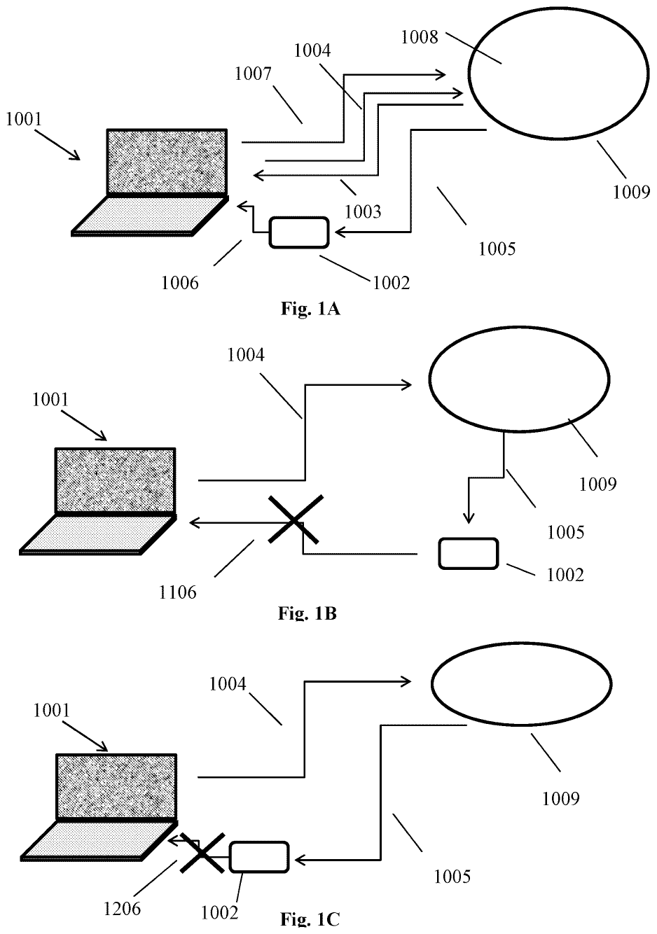

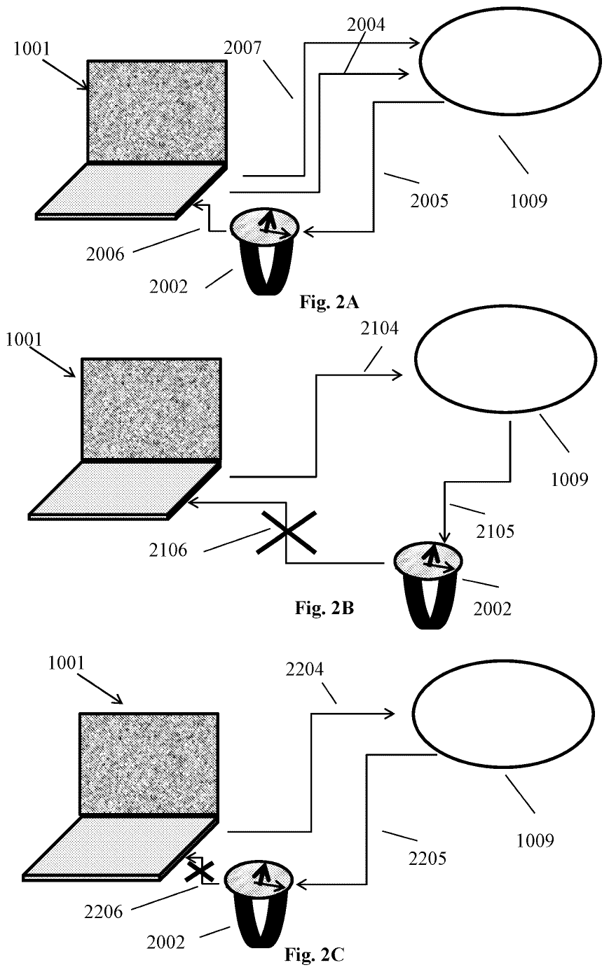

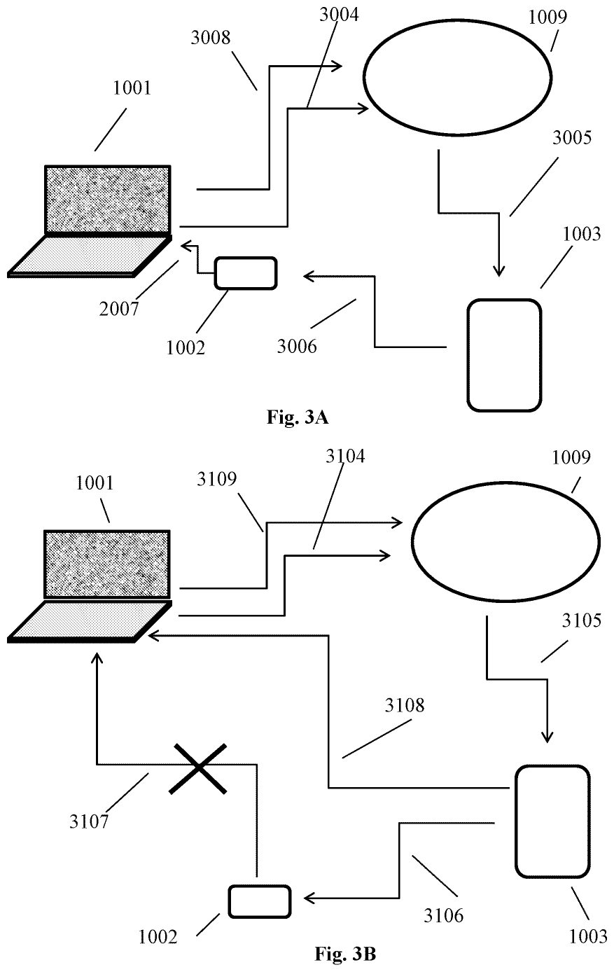

In accordance with one embodiment of the invention, FIG. 1A shows an exemplary authentication circuit comprising an account server 1009 and two additional communication devices 1001 and 1002. In this example, a first communication device (e.g., main device) 1001 is a laptop computer (e.g., or any other type of communication such as a smartphone, etc.). A user of (e.g., or a user controlling) the main device 1001 may wish to access a (e.g., his/her) (e.g., password) protected account within an account server 1009 (e.g., such as a website of a bank, an online store, etc.), by using the main device 1001. The user may have/use a second communication device 1002 (e.g., an intermediate device, as described before). Any or all of the main and intermediate device may preferably have a receiver and at least one transmitter for, respectfully, receiving and sending/transmitting signals/information/data. In this example, the main device 1001 and/or said intermediate device 1002 may preferably have and use a transmitter having (e.g., or be adjusted to have) a limited transmitting range (e.g., less than 10 meters, or less than 5 meters, or less than 1 meter, or less than 30 centimeters, less than 10 centimeters, etc.) (e.g. herein may be referred to as “short-range transmitter”, “Near Field Communication system (NFC) (e.g., NFC is described later in this patent application), etc.). In order to receive an information/signals from the intermediate device, the main device 1001 may preferably be/should-be in the transmission range of (e.g., herein, may be referred to as, “close to/near”) the intermediate device 1002, or vise versa. According to one aspect, when said devices are closed to each other, communication between said devices may, preferably automatically, be established. According to another aspect, when said devices are closed to each other, communication between said devices may be established upon (e.g., manually) pairing said devices.

In order to access his/her protected account (e.g., without using a/the password), a user controlling the main device 1001, at first may preferably open the log in webpage of a corresponding account server, on the (e.g. screen of the) main device 1001. Then, preferably, through said main device, the user may send 1004 a (e.g. at least one) predefined information (e.g. a username, an email address, an identification number, (e.g., a serial number of the main device), etc., provided, previously, during the/a corresponding sign-in procedure) required by the account server 1009 for logging in to his/her protected account, to the corresponding account server 1009. Upon accomplishment of a condition (e.g., after verifying and validating said information by the account server 1009), the account server 1009 may preferably transmit/send 1005 a second information (e.g., a (e.g. dynamically calculated/created) random and/or a predefined and/or a calculated security code/password, etc., which herein may be referred to as a, “security code”) to the intermediate device 1002. Preferably, said security code is sent in an encrypted manner. An encryption key/code may be used for encrypting the security code (e.g., by the account server). In this case, simultaneously or under accomplishment of a condition, a (e.g., corresponding) decryption key/code (e.g., said encryption key (e.g., herein may be referred to as “decryption key”/“decrypting key”/“encryption key”)) for decrypting said encrypted security code is preferably sent/transmitted 1003 by, preferably, the account server 1009 to the main device 1001. (e.g., optionally, the encrypted security code is sent to the main device and the decrypting key is sent to the intermediate device). Upon receiving said security code by the intermediate device 1002, said intermediate device 1002 may preferably automatically transmit 1006 said security code (e.g., or another security code in relation to/based on said security code) to the main device 1001. Note that, a decryption key/code is, generally/preferably/always, the same/similar key/code used for encrypting a/said security code.

According to one embodiment, the decryption key is sent by the account server to the main device after accomplishment of a condition such as after the/a corresponding encrypted security code (e.g., received by an intermediate device (e.g., from the account server)) is sent by/transmitted from the/an intermediate device to a/the corresponding main device. According to another embodiment, the decryption key is sent by the account server to the main device after accomplishment of a condition such as after the/a corresponding encrypted security code (e.g., sent by the account server to an intermediate device) is received by/in the main device (e.g., from the/an intermediate device). In the current embodiments, the account server is preferably informed of the accomplishment of any of said condition by a means such as by a message sent from at least one of, said intermediate device, said main device and the/a controlling application/server (e.g., a controlling server and/or application will be described later in this patent application) to the account server.

Preferably, the decrypting key is sent to the main device through the Internet (e.g., by using the IP address of the main device). Alternatively, said key is sent to the main device by another messaging system such as SMS (e.g., through another communication system such as a cellular system).

After receiving the encrypted security code from an/the intermediated device (e.g., by the main device), the encrypted security code is decrypted (e.g., within the main device) using said decryption key. According to a preferred method, the decryption process is done/executed by a software of the account server (e.g., transmitted to main device by the account server (e.g., during the login procedure) and preferably running on the main device). Alternatively, the decryption process is done/executed by (e.g., a portion of) the controlling application preferably running within the main device. Alternatively, the decryption procedure may be executed by a third party application and/or within a remote/another device to which said encrypted security code and the decryption code/key are transmitted (e.g., by the may device). In this case preferably the decrypted security code is transmitted to the main device (e.g., and/or directly to the account server.)

Preferably, the encrypted security code is sent to the intermediate device by a messaging system such as SMS. Alternatively, the encrypted code/key is sent to the intermediate device through the Internet (e.g., by using the IP address of the intermediate device). Note that each of the main and intermediate device may preferably be a standalone device having a different cellular communication number (e.g., a different/separate STM card with a different phone number).

Optionally, a/the contact information (e.g., a telephone number) of the main device is provided by the user (e.g., or automatically captured by the account server) preferably during the log in procedure within (e.g., optionally, during the sign-in procedure of) said protected account. Said contact information may be used by the account server 1009 for sending said/a decryption key to the main device 1001 for decrypting said/a-corresponding encrypted security code (e.g., by/in the main device 1001) during a log in procedure. In this example, in server 1009, a number of information 1008 provided through a/the corresponding sign-in procedure (e.g., account identification (ID), password, telephone number of the intermediate device 1002 and telephone number of the main device 1001) are stored and preferably at least some of said information may be used during a corresponding log in procedure.

If said/the security code is encrypted, then, a key for decrypting said security code is (e.g., simultaneously) sent by the account server 1009 to the main device 1001 (e.g., by using the contact information (e.g., IP address of the main device 1001 or by using the telephone number of the main device 1001, if provided or captured during log in procedure and/or during sign-in procedure, or otherwise, etc.).

With continuous description of the current embodiment, upon receiving said security code by the main device 1001 (e.g., from/through the intermediate device), if said security code is received in an encrypted manner, then, said main device, may preferably, use said decrypting key for, decrypting said security code.

According to a first aspect, (e.g., after being decrypted) said security code is presented/displayed on the screen of the main device 1001. At this time, a person controlling the main device 1001 may enter, manually (e.g., type/copy-and-paste), said security code within a predefined input field (e.g., text field) of a/the log in interface of the account server displayed on the screen of the main device. Then, preferably, upon providing an interaction by the person controlling the main device (e.g., upon pressing a send button) 1001, the main device may send/transmit 1007 the received (e.g., decrypted) security code to the account server 1009.

According to a second aspect, a controlling application (e.g., a controlling application is described in this patent application) running within the main device 1001 may, preferably automatically, transmit 1007 the received (e.g., decrypted) security code (e.g., or a security code related to, or calculated based on said security code) to the account server 1009.

(According to a third aspect, upon receiving said security code, by the main device 1001, from the intermediate device 1002, another entity may send said (e.g., decrypted) security code to the account server 1009).

After receiving the (e.g., decrypted) security code from the main device 1001 by the account server 1009, the main device 1001 is, preferably, given access to the corresponding (e.g., user's) protected account (e.g., in the account server) (e.g., the user is logged in to his/her protected account and a corresponding webpage is preferably opened on the screen of the user's device 1001 for navigation in the user's protected account.).

The procedure of sending a request from the main device to an account server for logging in to a protected account, followed by sending a security code from by the protected account server to an intermediate device, and so on (e.g., the rest of the authentication procedure/circuit of the invention is executed), until the protected account server receives back said security code (e.g., or another security code related to and/or based-on said security code) from the main device may be referred herein as an “authentication procedure/circuit/system”.

As mentioned, the intermediate device 1002 may preferably use a transmitter with/using limited transmitting range (e.g., system). Therefore, as shown in FIG. 1B, if the main device 1001 is outside of (e.g., is far from) the range of said transmitter of the intermediate device 1002, then, communication between the intermediate device 1002 and the main device 1001 may not established 1106 and the main device 1001 may not receive the corresponding/said security code from the intermediate device 1002. In this case, the authentication circuit/procedure is not completed (e.g., is interrupted) and the main device 1001 cannot/will-not have an access to the corresponding user's protected account. According to one method, the intermediate device 1002 may preferably continue/repeat (e.g., the attempt) to send the security code to the main device 1001, preferably, for a predefined laps of time (e.g., after which the security code preferably becomes invalid (e.g., by the account server 1009)). According to another method, after a predefined laps of time, the intermediate device 1002 ceases (e.g., the attempt) to repeatedly send the security code to the main device, etc.).

According to one method, when an account server receives (e.g., back) a/the security code from a/the main device, preferably, said account server checks if said security code had been sent by the account server to an intermediate device during a predefined lapse of time before receiving said security code back from main device. If said security code had been sent to the intermediate device before said predefined laps of time, then, preferably, said the account server considers said security code as invalid. The user then may preferably be required/obliged to proceed the login procedure again.

In continuation description of the current embodiment, according to another method, the laps of time between the moment a security code is sent from the account server 1009 (e.g., to an intermediate device) until the moment the account server 1009 receives back said (e.g., decrypted) security code (e.g., or a security code related to/based on the security code sent by the man device) from the main device 1001 may be limited to a predefined amount of time (e.g., less than 5 minutes, less than 1 minute, less than 10 seconds, less than 5 seconds, less than 1 second, less than 500 milliseconds, etc.), after which said security code becomes invalid and an authentication circuit will not be completed/accepted by the account server. In this case, a new request for connection/login to said protected account may be sent by (the user of) the main device 1001 to the account server 1009, and so on. According to another method, the laps of time between the moment a security code is sent from any of the devices of the authentication circuit to another device of said circuit and received by said another device may be limited to a predefined amount of time (e.g., as described herein), after which said security code becomes invalid. In this case, a new request for connection to said protected account may be sent by the main device 1001 to the account server 1009, and so on.

The method of accessing a protected account described above is secure, easy and has many advantages. According to a first scenario, as mentioned, in order to get access to a desired protected account, the main device 1001 and the intermediate device 1002 must preferably be near/close to each other. As an example, if both devices are at/in a user's home near each other, the user can securely connect to any of his/her desired protected accounts. On the other hand, if the user takes his main device 1001 with him outside his home, then, the user will not be able to connect to/login into a desired protected account because the intermediate device 1002 is remained at user's home far from the main device 1001. As such, if one of the user's devices 1001 or 1002 is, for example, lost or stolen, the person controlling/possessing the lost or stolen device cannot access any of the user's protected accounts through said lost or stolen device. According to a second scenario, as shown in FIG. 1C, for more security, the intermediate device 1002 may have a (e.g., physical and/or virtual) feature/means for manually interrupting (e.g., and/or establishing) the communication 1206 between the intermediate device 1002 and the main device 1001 (e.g., by, for example, turning off/on (e.g., the corresponding transmitter of) the intermediate device, turning off/on the NFC reader of the main device, etc.). In this case, preferably, said communication may generally be interrupted, and a user may, preferably, manually establish the communication between the intermediate device and the main device when needed/desired (e.g., by turning on the (e.g., the transmitter of) the intermediate device using said feature/means) such as only when the user desires to access a (e.g., remote) protected account. According to a third scenario, a security key received by an intermediate device is transmitted to the main device by a manual/physical authorization action provided by a/the user controlling said intermediate device. As an example, after a security code sent by an account server is received by an intermediate device, a request for authorization may be presented (e.g., by the controlling application) to the user controlling said intermediate device. Preferably said request may be in form of an intractable interface/button displayed on the screen of the intermediate device. Upon interacting with said interface/button said received security code is preferably sent to/transmitted from the main device by/from the intermediate device.

According to one embodiment of the invention, an intermediate device (e.g., 1002) may (e.g., also have, and) use (e.g., in specific/certain situations/condition, based on a user's command, etc.) a long-range transmitting technology (e.g., Internet, cellular, Wi-Fi, etc.) during an authentication procedure. In specific conditions/cases, said long-range transmitting technology may be used by the intermediate device, for preferably transmitting the/a security code received (e.g., by said intermediate device 1002) from the account server (e.g., 1009) to the main device (e.g., 1001). In this case, even if the intermediate device is far from the main device, the intermediate device may be able to send said security code to the main device successfully. As an example, an authentication circuit with an intermediate device (e.g., within an/the authentication circuit) (e.g. 1002) using a short-range transmitter/transmitting-technology may be used for accessing highly-sensitive protected accounts (e.g., bank protected accounts, online stores, etc.), and an authentication circuit with an/said intermediate device (e.g., 1002) using a long-range transmitter may be used for accessing low-sensitive protected accounts (e.g., an online library protected accounts, online media protected accounts, etc.). Any of the devices of an authentication circuit may preferably have, both, a short-range transmitter and a long-range transmitter.

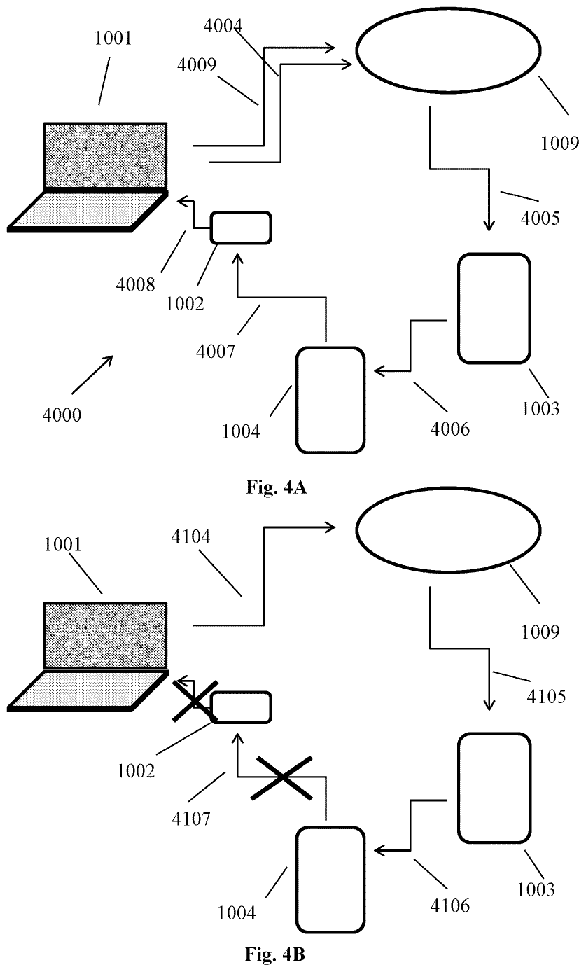

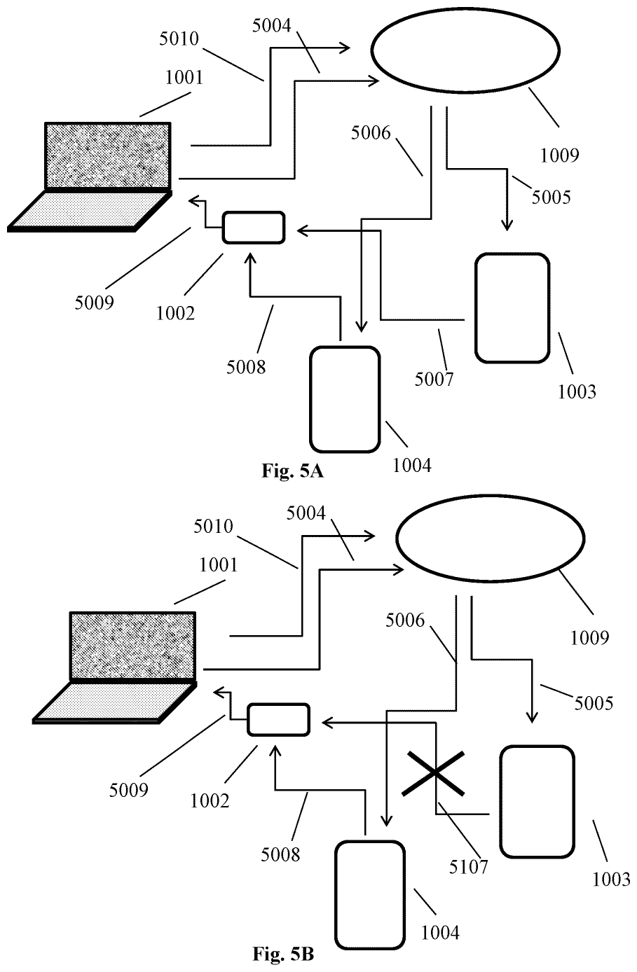

The/an intermediate device may be of any kind. According to one embodiment, as shown in FIG. 2A, the intermediate device may preferably be a wearable device 2002 (e.g., a wrist device such as a smartwatch). A wearable intermediate device may be very advantageous because it is usually worn by a user and most probably cannot be lost or stolen (e.g., together with a/the corresponding main device). Preferably, the wearable (e.g., the intermediate) device 2002 uses a transmission technology for/limited-to a very short distance/range as described above (preferably, less than 50 or 30 or 20 centimeters). This is because the distance between the intermediate device (e.g., the smartwatch) 2002 and the main device (e.g., a laptop, a smartphone, etc.) 1001 is usually very short (e.g., less than thirty centimeter) when a user wears the intermediate device and interacts with (e.g., uses (e.g., types on) a keyboard of) the main device. In this case, the authentication circuit/procedure is highly secured (e.g., a person other than user wearing said smartwatch and not carrying the main device cannot access a protected content/account (e.g., of the user)).

In the current embodiment, as shown in FIG. 2B, if the main device 1001 is far from (e.g. is out of the transmission range of) the user's wrist device 2002 and/or that of the main device 1001, for example, because the wrist device is lost or stolen, the authentication circuit cannot be completed because a/the communication 2106 between the wrist device 2002 and the main device 1001 cannot be established, and accordingly, an authentication procedure/circuit will not be completed. As such, a third party who controls the main device 1001 cannot access to any of the user's (remote) protected accounts.

According to one embodiment, as shown in the exemplary FIG. 2C, for more security, the intermediate/wrist device 2002 (e.g. and/or the main device) may have a (physical and/or virtual) feature for manually interrupting and/or establishing the communication between the intermediate/wrist device 2002 and the main device 1001 (e.g., by turning (e.g., the transmitter of) the intermediate/wrist device and/or the/a (e.g., NFC) reader of main device, off or on). In this case, a user may, preferably, manually establish the communication between the intermediate/wrist device (e.g., only) when needed/desired (e.g., by turning on the (e.g., the transmitter of) the intermediate/wrist device or (NFC) reader of the main device) such as when the user desires to access a remote protected account.

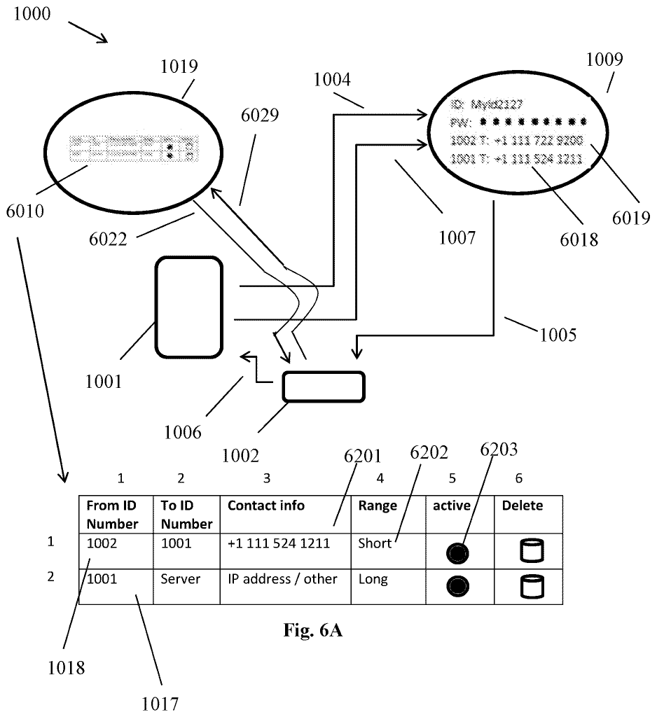

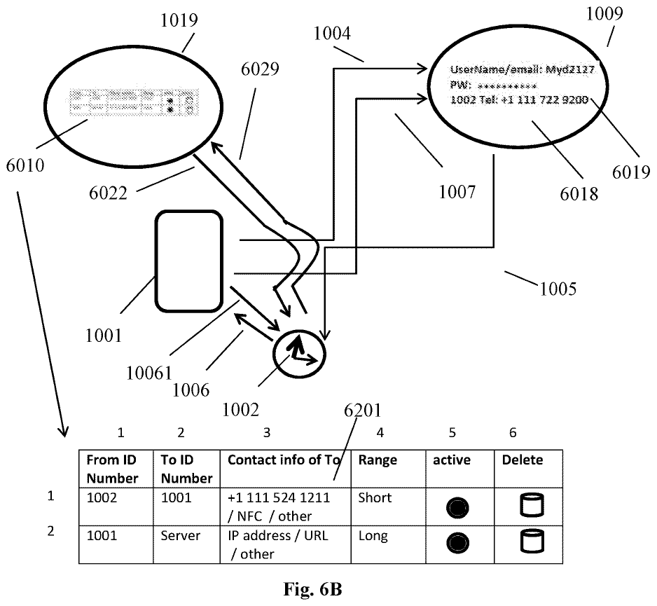

According to one embodiment of the invention, the authentication circuit may have more than one intermediate device (e.g., such device may herein be referred to as, an “additional intermediate device”). As an example, as shown in FIG. 3A, an additional intermediate device 1003 such as a smartphone (e.g., of a third party, such as a family member of the user), may be defined to be an additional intermediate device of the/an authentication system/circuit. In this case, after a request 3004 is sent by a main device 1001 to access a (e.g., remote) protected account within the account server 1009, a security code may be sent 3005 by the account server 1009 to an additional intermediate device 1003, then said security code is sent 3006 by said additional intermediate device 1003 to the intermediate device 1002, and then the security code is sent 2007 from the intermediate device 1002 to the main device 1001, and then, the security code is sent 3008 from the main device 1001 to the account server 1009 for completing the authentication circuit/procedure. It is understood, that in accordance with this embodiment, the contact information of an intermediate device provided during the corresponding sign-in procedure to the account server, is preferably the contact information of the additional intermediate device 1003.

The current embodiment has many advantages. As an example, as shown in FIG. 3B, if, for some reason, a connection between the intermediate device 1002 and the main device 1001 cannot be established 3107 (e.g., because the intermediate device 1002 is far from the main device 1001), then, the user may get in contact through a predefined procedure (e.g. such as a phone call) with the party controlling the additional intermediate device 1003, and upon agreement, said party may provide/send 3108 the received security code directly (e.g., through an SMS/email, etc.) to the main device or provide (e.g., verbally) said security code as is (e.g., in encrypted or non-encrypted form) to the user controlling the main device 1001. Then, the (e.g., user of the) main device may send said security code to the account server 1009 for completing the authentication procedure/circuit.

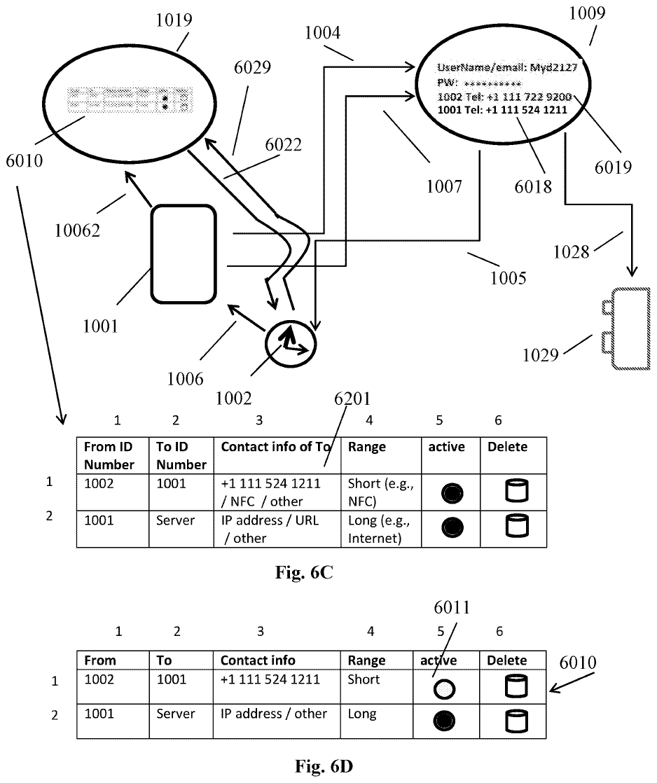

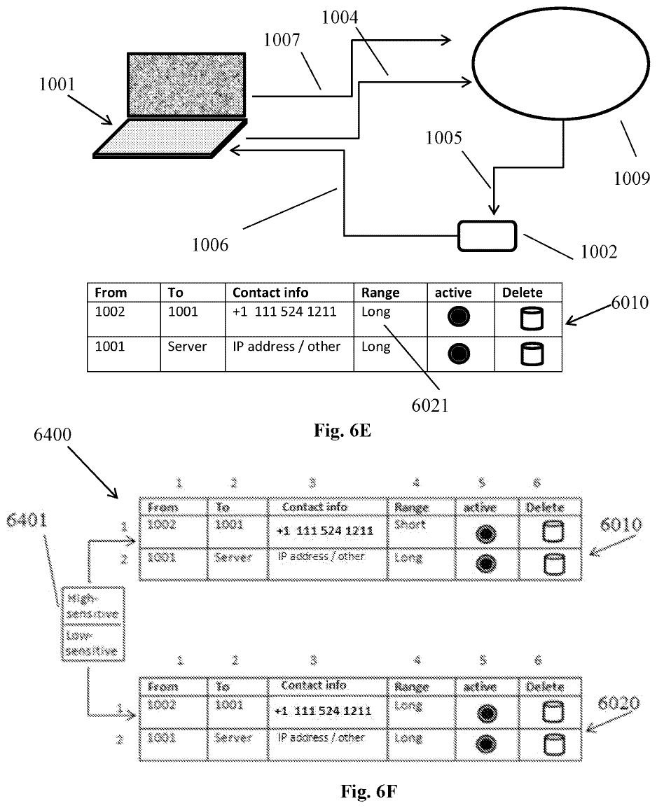

According to one embodiment, as shown in FIG. 4A, an authentication circuit may have more than one additional intermediate device communicating to/with each other (e.g, in a serial manner and/or in a parallel manner) to create an authentication circuit. In the example of FIG. 4A, at first an access request is sent by the man device 1001 to the account server 1009. (e.g., After verifying and validating the authenticity of the identification of the main device 1001, or of the person controlling the device 1001), the account server may send 4005 a security code to a first additional intermediate device 1003 in the authentication circuit 4000. The intermediate device 1003, may then transmit 4006 the security code to a second additional intermediate device 1004. Then the additional intermediate device 1004 may send 4007 said security code to the intermediate device 1002 (e.g., the intermediate device that is in charge of sending the information (e.g. security code) to the main device). The intermediate device 1002 may then send 4008 the security code to the main device 1001. Finally, said security code is sent 4009 by the main device 1001 to the account server 1009, to complete the authentication circuit.

With continuous description of the current embodiment, as shown in FIG. 4B, if any/one of the intermediate devices (e.g., 1004) is not available (e.g., is turned off), the authentication circuit cannot be completed and the user cannot access a/the desired protected account.

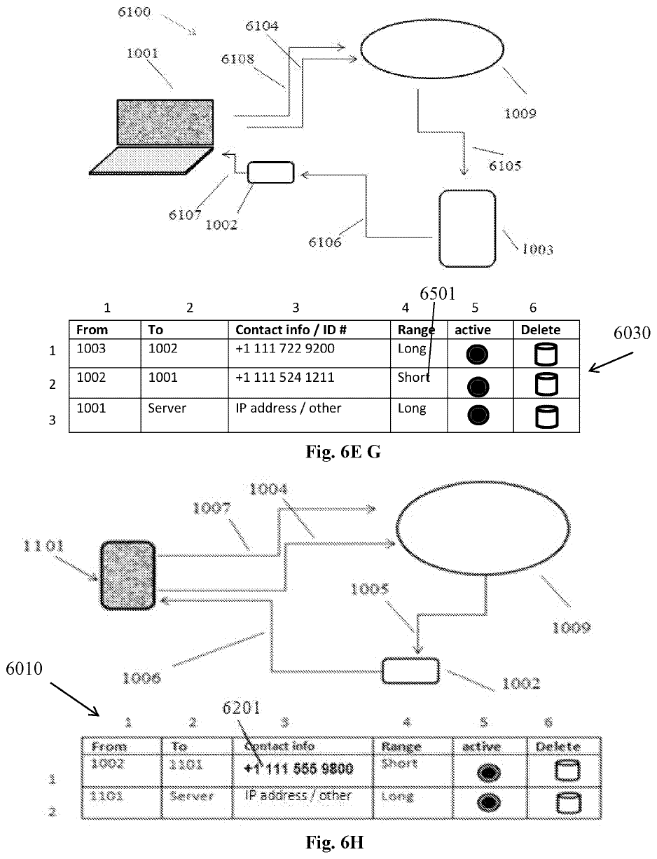

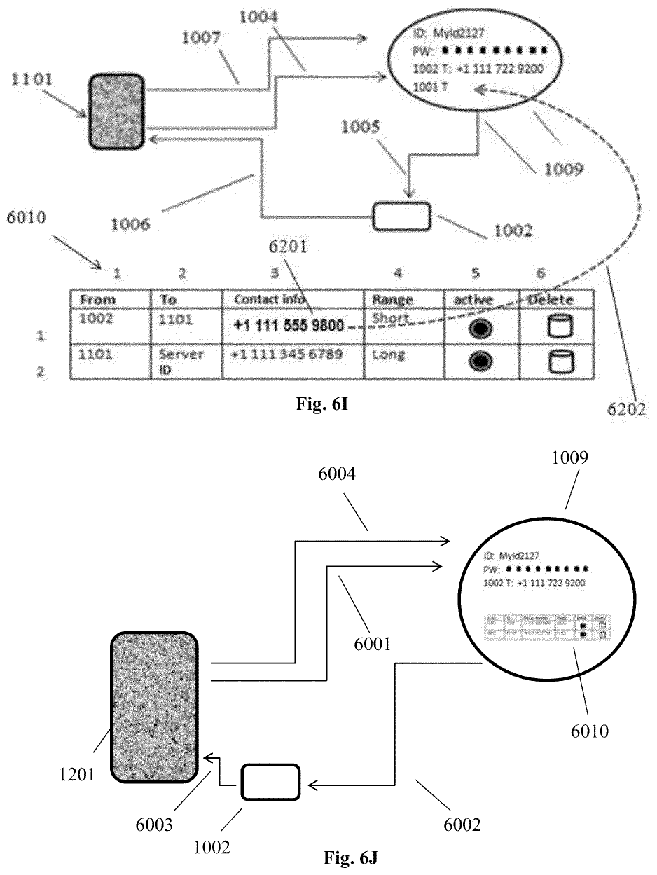

According to one embodiment, as shown in FIG. 5A, an authentication procedure/system may have more than one authentication circuit. Preferably, said authentication circuits work in a parallel manner (e.g., and, preferably, independently from each other). FIG. 5A shows, as an example, an authentication system/circuit having a number of devices similar to the devices of the system/circuit of FIG. 4A. In this example, when a request for accessing an protected account is sent 5004 by a main device 1001 to an account server 1009, the account server 1009 may send (5005 and 5006) a (e.g. a different or the same) security code to each of a plurality of (predefined) additional intermediate devices (e.g. in this example, respectfully, to the additional devices, 1003 and 1004). Then, each of said additional intermediate devices may, preferably independently from each other, send (e.g., 5007 and 5008) the received security code to the intermediate device 1002. Then, the intermediate device 1002 may send 5009 at least one of the received security codes to the main device 1001. Then, the main device 1001, automatically or by the intervention of the user controlling the main device (e.g. by typing the security code (e.g., after being decrypted in the main device 1001) received from the/an intermediate device in a predefined text field), may send 5010 the received security code to the account server 1009 for completing the authentication procedure.

The current embodiment is very advantageous. As an example, as shown in FIG. 5B, if for any reason one or more of the plurality of additional intermediate devices (e.g., 1003) is/are not available (e.g., is/are turned off), the authentication procedure may still be accomplished if (e.g., only) one (or more) of the devices (e.g. 1004) of said plurality of additional intermediate devices is/are available. In this example, the additional intermediate device 1003 is, for example, turned off, therefore, the security code is not received by said device 1003 and/or cannot be transmitted 5107 by said device to the intermediate device 1002. On the other hand, the security code received by the additional intermediate device 1004 may be transmitted 5008 to the intermediate device 1002, and from there to the main device 1001. Then, the main device 1001 transmits said security code to the account server 1009 for completing the authentication circuit.

As mentioned before, a user may have created a number of different authentication circuit for a number of different account servers,

According to one embodiment of the invention, an intermediate device receiving a security code from an account sever, is preferably informed about/of the identification (“ID”) of said account server. Preferably, the account server sends its identification information (e.g., together/simultaneously-with the security code) to the intermediate device. Optionally, the intermediate device identifies the account server ID based on other information such as the telephone number by which the/a SMS containing said security is sent to the intermediate device. In this case, the intermediate device may send said identification information to the controlling server so that the controlling server use the corresponding authentication (e.g., parameters of the/a corresponding controlling) account (e.g., when communicating with the intermediate device). This step may be necessary for a controlling server having more than one controlling account.

According to one embodiment, a/the transmission direction of a security code within the/an authentication circuit may be in any predefined different manner. As an example, after sending an access/login request by a main device to the account server, the account server may send a security code to the intermediate device, and from there the security code may be sent to an additional intermediate device, and so on (e.g., the rest of the authentication procedure/circuit of the invention is executed).

Note that, the account server may send more than one security code to an (any) intermediate device. Also, for stronger/enhanced security, any of the devices within an authentication circuit may be able to produce one or more additional security codes (e.g., preferably based on the security code sent by the account server) and send them to another device in the circuit, and so on (e.g., the rest of the authentication procedure/circuit of the invention is executed).

Note that, any of the devices of/within an authentication circuit may (e.g., have and/or) use any communication technology such as Internet, cellular, Wi-Fi, Bluetooth, NFC (e.g., near field communication system), etc.

NFC system/technology is an evolution of RFID (radio frequency identification)) technology. NFC system operates on the principle of inductive coupling, for very short-range implementations (e.g., a few centimeters). This essentially involves the reader and/or writer device/component/chip generating a magnetic field by passing an electric current through a coil. When a tag (with its own coil) (e.g., herein may be referred to as “tag” or “Ntag”) is brought nearby, the field induces an electric current within the tag sans any wires or even physical contact. Then, once the initial handshake is complete, any stored data on the tag is wirelessly transmitted to the reader. This is to prevent accidental triggers especially important now that the technology is used for transferring sensitive data. Another noteworthy point is that devices can act as either an NFC reader (e.g., and/or writer) or a tag. This bidirectional capability allows to use one piece of hardware such as a smartphone/smartwatch for all kinds of different applications.

A NFC system has generally a NFC reader and/or writer (e.g., with a short-range (e.g., less than 10 centimeter) communication capability/range) component/chip (e.g. herein may be referred to as a “NFC component or NFC chip” or “NFC means or an active NFC)) and a NFC tag (e.g., or an emulation of NFC tag/card (herein may be referred to as a “tag” or “Ntag” or “NFC card”).

Systems for emulation of an NFC tag/card is known by the communication industry and/or peoples skilled in the art. As an example, many Android-powered devices that offer NFC functionality already support NFC card emulation. In most cases, the card is emulated by a separate chip in the device, called a secure element. Many SIM cards provided by wireless carriers also contain a secure element. Android 4.4 and higher provide an additional method of card emulation that doesn't involve a secure element, called host-based card emulation. This allows any Android application to emulate a card and talk directly to the NFC reader.

A NFC tag has a restricted memory to store a small amount of data (e.g., a few hundreds of bytes). Usually a few number of bytes of said memory are used to store the identification number of the tag.

According to one embodiment of the invention, an authentication system/circuit of the invention may include/use an application (e.g. herein may be referred to as “controlling application”) for defining and/or controlling an authentication circuit/procedure. Said controlling application may have/use (e.g., a protected account within) a (e.g., its own) server (e.g., herein may be referred to as a “controlling server), wherein said controlling server is preferably separately/independently from an account server. Said controlling server is controlled preferably by an administrator (e.g., herein may be referred to as an “admin of the/a controlling server”) which, preferably, is the person who controls/owns the main device of the authentication circuit.

Preferably, said controlling application, and/or a derivative (e.g. a specific version) of said application, is at least installed on one or more (e.g., preferably all) of the devices of an authentication circuit (e.g., account server of an authentication circuit may be excluded). Preferably, said application has/uses a protected account (e.g., within the/a corresponding controlling server) containing some information/data (e.g., parameters (e.g., herein may be referred to as a “controlling account”) within a server (e.g., herein may be referred to as “controlling server”), through which the devices of a corresponding authentication circuit are defined and/or their behavior is controlled. Through a controlling account, behavior of devices of an authentication circuit (e.g., during an authentication procedure) may preferably be defined, modified and/or controlled. The controlling account can also be used for controlling a (e.g., said) corresponding controlling application installed on a device. As an example, the admin of the controlling account can/may-be-enabled to access the controlling server to create an (e.g., a new) authentication circuit and its behavior (e.g., relationship between the device of the authentication circuit). Then, the admin of the controlling account (or another person who has an access to the controlling account) may cause modification/s to definition (e.g., to the parameters) of an already created authentication circuit and/or its behavior. Note that a controlling account is preferably protected by at least a password and a username. A/The controlling application of the invention, running within a device of an authentication circuit of the invention, may execute many/some tasks including but not limited to receiving an information (e.g., such as a security code) from an account server or from another device within the authentication circuit, analyzing and/or processing the received information, decoding/encoding an/the information, connecting to the controlling server, sending/transmitting an/the information (e.g., said security code) to another device within the circuit, etc. Said controlling application may also include an (e.g. on or more) (interactive) interface/s for processing (e.g. viewing, editing, entering, storing, etc.) data. As an example, after receiving a security code (e.g., sent by/transmitted from a first (e.g., an intermediate)) device, by the controlling application (e.g., or by a derivative/portion of it), preferably installed on said first device) by a second (e.g., main) device, said security code may be viewed (e.g., by the controlling application or a derive/portion of it, preferably installed on said second device) on the screen of the second device. Optionally, said controlling application and/or a derivative/portion of it running within the second device may provide/deliver/pass/transfer the received security code from the first device to a/the corresponding application of the account server running within the second device for example for being decrypted by said application of the account server. After being decrypted, the decrypted security code may be presented by/on the second device. Then, a person controlling said second device, may, manually, enter (e.g. type/copy-and-paste) said security code within an interface (e.g., of the controlling application or of the interface of a corresponding account server) of said second device and send it to a third device (e.g., the main device or to the account server, etc.).

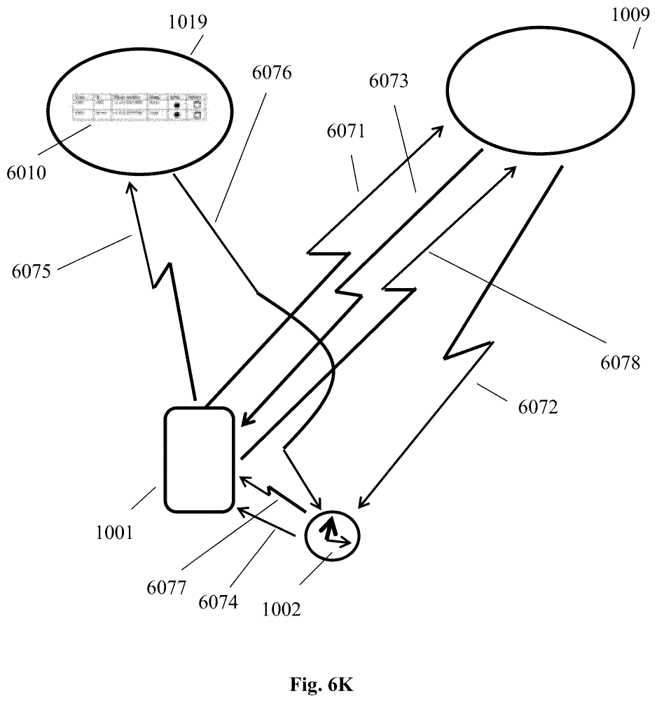

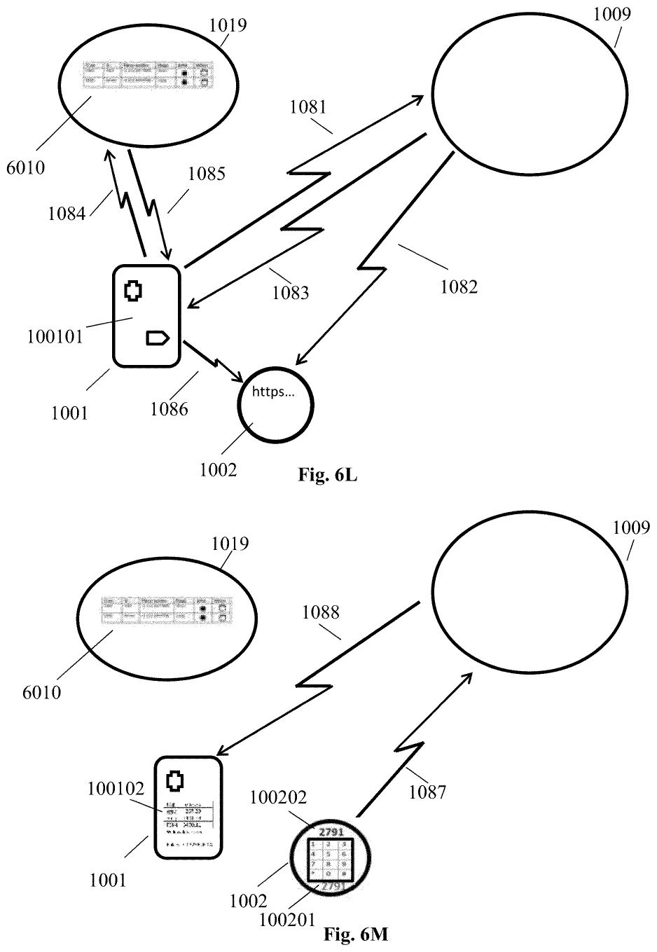

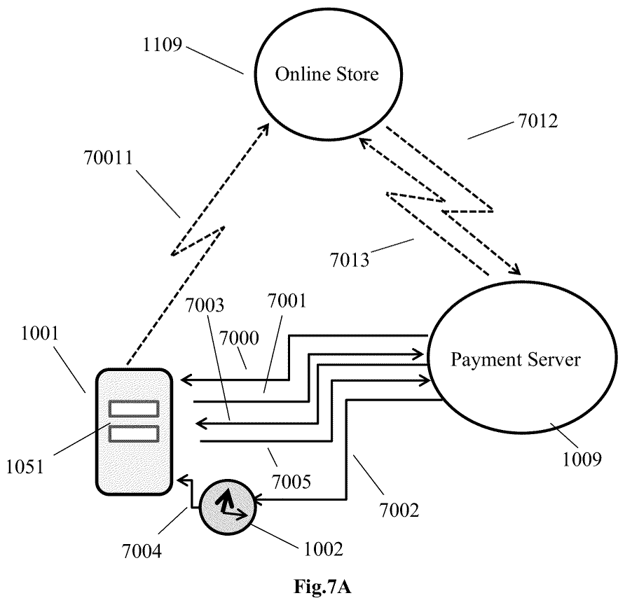

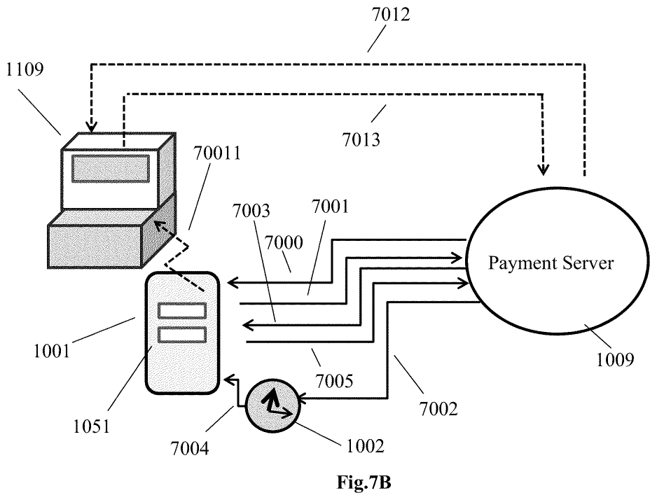

As mentioned, a controlling application/software may have/use a (e.g., corresponding) controlling account within a (e.g., remote/cloud) controlling server (e.g., 1019) to store and/or use some information/data (e.g., one or more controlling parameters, which herein may be demonstrated through an exemplary interface in form of a table of parameters (e.g., 6010). Such table may herein be referred to as a “controlling table”). FIG. 6A, shows an exemplary controlling table 6010 (e.g., within a controlling account 1019) of/used by the/a controlling application of the invention. In this example, said controlling application is installed and running (e.g. in the background) within at least one of, a main device 1001 and an intermediate device 1002. Said controlling application uses the information stored in said controlling table for controlling an/the exemplary authentication circuit (e.g., 1000) similar to that of FIG. 1A.

FIG. 6A, also shows as an example, said controlling server 1019 which is used by (e.g., provides service to) a controlling application of the invention. In this example, the controlling server 1019 holds/has (e.g., at least) one/an exemplary user's controlling account in which a table 6010 (e.g., created/defined/instantiated (e.g., by an admin of said controlling account) for controlling the authentication circuit 1000) related-to/used-by the controlling application is stored.

In this example, said interface is in form of exemplary table 6010 after being filled (e.g., by an admin of the corresponding controlling sever (e.g., the user controlling the device 1001)) with some information corresponding to a/the desired authentication circuit such as that of FIG. 1A. When a user desires to create an authentication circuit, he/she may enter/provide the required information within such a table. In this example, said admin of the corresponding controlling server has entered some information such as information about at least some of the devices of the authentication circuit, relation between each device with another device of said circuit, etc. In this example, each horizontal row of the table 6010, is dedicated to some information regarding a device of an authentication circuit.

It is understood that the table for integrating and using controlling parameters is described here as an example. Other methods for integrating/defining controlling parameters within/used-by a controlling application may be defined/created by people skilled in the art.

According to one aspect, the controlling account may be used for storing and/or executing a software for controlling an authentication procedure. Optionally, instead of or in addition to said software another software controlled by a controlling application of the invention may be used (e.g., or vise versa).

Preferably, a sign-in procedure and a log in procedure, requiring at least an identification information and a password, is required for, respectively, creating a (e.g., a corresponding controlling table/parameters within said) controlling account and logging in to said controlling account (e.g., for modifying said controlling table). Preferably, said sign-in and log-in procedures are possible through a browser/Internet. According to one aspect, said controlling account may be logged in to by/through said controlling application.

In order to use a memory space (e.g., a controlling account) within or and/or related to a controlling server for storing some controlling data (e.g. creating a table of parameters), a user may first create a protected account by executing a sign-in procedure including providing some information (e.g., at least an identification information and a password) to the controlling server. Then, each time said/a user desires to access a controlling account, he/she may preferably have to go through a log in procedure requiring submission of some information such as said identification information and a password by said user. This password is preferably, the only password that a user may keep on mind/remember it or keep it handy because as will be described later herein, in some cases, a user may want to access a controlling account within a controlling server to for example change one or more parameters.

With continuous description of the current embodiment, as an example, in table of parameters 6010 each horizontal row defines a different device and the behavior of said device within/of the exemplary authentication circuit 1000 of the invention. As an example, by considering the horizontal row 1, of the exemplary table 6010:
in column 1, the (e.g., unique) reference/identification number (e.g., serial number) (e.g., herein may be referred to as “ID number”) of the intermediate device (e.g., in this example, 1002) which is adapted/defined to receive a security code from an account server is entered.
in column 2, the reference/identification number (e.g., serial number)/ID number of the following device in the authentication circuit (e.g., in this example, 1001, the main device) to which said security code will be redirected by the intermediate device (e.g., in this example, 1002), is entered.—in column 3, the telephone number of the following device (e.g., in this example, 1001) to which said security code will be redirected is entered.
in column 4, an admin of the controlling server/account can define which one of the transmitters (e.g., short-range or long-range) or which transmission technology of the device 1002 should be used for transmitting a received security code to the following active device (e.g., in this example, 1001).

Preferably, by default, said transmission technology is an NFC system.
in column 5, an admin of the controlling server/account can activate or deactivate the current intermediate device (e.g., in this example, 1002) in the authentication circuit. If the button is in Inactive status, then the intermediate device is not authorized to transmit the security code to the/following main device.
in column 6, an admin of the controlling server/account can delete/remove the current intermediate device (e.g., in this example, 1002) from the (e.g., current) authentication circuit.

According to a first method, after receiving an/the encrypted security code by/within the intermediate device, said security code is written by the NFC writer of the intermediate device within an Ntag (e.g., or alternatively within a storage (e.g., related to the Ntag emulator)) of the intermediate device. Then, after (e.g., getting the authorization from the controlling server, and) approaching the intermediate device to the main device so that a NFC communication is established between the two device, then the encrypted security code is read by the NFC reader of the main device from the Ntag of the intermediate device. As such, the security code is transferred from the intermediate device to the main device.

According to second method, after receiving an/the encrypted security code by/within the intermediate device and (e.g., getting the authorization from the controlling server, and) approaching the intermediate device to the main device so that a NFC communication is established between the two device, then the encrypted security code is written by the NFC writer of the intermediate device within an Ntag (e.g., or alternatively within a storage related to the Ntag emulator) of the main device. As such, the security code is transferred from the intermediate device to the main device (e.g., either by the intermediate device (e.g., by sending the security code to the main device) or by the main device (e.g., by retrieving the security code from the intermediate device)).

According to one embodiment of the invention, a circuit controlling account may be created by a “handshake” between a main device and an intermediate device, preferably through a NFC communication system (e.g., by approaching the main device and the intermediate device to each other to a distance (e.g., less than ten centimeters)) such that a NFC is established between the two devices. For such purpose, a sign-in page of a controlling server/application may be accessed by the user on preferably his/her main device or another device. The user may, first, fill/provide some preliminary information such as a username (e.g., a user's email, user's telephone number, etc.), a password, etc. After entering said preliminary information, the user, may be required by the controlling application to approach the main device and an intermediate device so that a NFC communication becomes established between the two devices. At-this-time/thereafter, one or more (e.g., unique) information/ID of the two devices (e.g., such as at least one of, a serial number of the main device, a serial number of the intermediate device, a corresponding SIM-card/telephone number of one (e.g., or both) device/s, the NFC tag ID of the intermediate and/or of the main device), etc., may, preferably automatically, be transmitted to the corresponding account server, preferably, through the main device, alternatively through the intermediate device. Said information may be used by the controlling server for controlling the interaction between the devices of the authentication system of the invention (e.g., as described throughout this patent application). Thereafter/by-doing-so, the sign-in procedure for creating a controlling account may be accomplished. Preferably, by default, the transmission of a security code between the intermediate device and a corresponding main device is defined to be through an NFC system.

With continuous description of the instant embodiment, an admin of a created controlling account may login into the created account (e.g., by using the/said username and/or password) and define and/or modify one or more other parameters such as “active”, “pause”, selected communication system (e.g., “short”, “long”), etc. status of a device, as described throughout this patent application.

In the current embodiment, when a first (e.g. an intermediate) device of the (e.g., two) devices of an authentication circuit attempts to access a/the corresponding controlling account within a corresponding controlling server, the unique ID (e.g., serial number) of at least said device and/or the following (e.g., the main) device is preferably (e.g., automatically) transmitted to the controlling server. If the transmitted unique ID matches the unique ID of said/a device provided during the sign-in procedure of the controlling account, then the controlling server gives/permits an access to the corresponding controlling account, to said device. At this time, as an example, (e.g., the user, or) a corresponding application running within said device may consult the/a data stored within said controlling account. Said data may permit to verify some information such as, if said (e.g., intermediate) device is authorized to send/transmit a received (e.g., encrypted) security code to a second/following (e.g., main) device, the unique ID of said second (e.g., main) device, etc. If the first device is authorized to transmit the (e.g., encrypted) security code to said second device, then according to one method, before said transmission, said application running within the first device may preferably (e.g., intercept (e.g., through a NFC system or through a long-range communication system) and) compare the unique ID of said second device with the unique ID of the second device received-from/the corresponding controlling account within the controlling server. If both unique IDs are identical, then said transmission is executed (e.g., preferably, through NFC).

In the instant embodiment, for the purpose of better identification, when a first (e.g. an intermediate) device of the (e.g., two) devices of an authentication circuit attempts to access a/the corresponding controlling account within a corresponding controlling server, in addition to the unique ID (e.g., serial number) of said first device a/the unique ID of the second device is preferably also transmitted to the controlling server for verification for the purpose of the access permission.

According to one method, a server controlling the transmission of information (e.g., a security code) from one device to another device (e.g., such as the controlling server of the invention, a messaging system used by the controlling/authentication system of the invention, etc.) may assign/attribute a unique ID number (e.g., a token) to each of the devices of a corresponding authentication circuit. According to another method, a server controlling the transmission of information (e.g., a security code) from one device to another device (e.g., such as the controlling server of the invention, a messaging system used by the controlling/authentication system of the invention, etc.) may use a unique (e.g., identification) code/number (e.g., a serial number of the corresponding device, the telephone number of the corresponding device, etc.) of each of the devices of a corresponding authentication circuit as the/a ID number of a corresponding device. Note that other methods of assigning and/or using a unique identification information may be assigned and/or used for the same purpose.

According to a first method, an ID number of a device may be a provided (e.g., to the controlling server) automatically. As an example, the ID number of a device may be its serial number which may be automatically captured by a controlling server (e.g., when an admin of a corresponding controlling account accesses said controlling server (e.g., with said device for creating or modifying a corresponding controlling account).

According to a second method, an ID number of a device may be a unique information (e.g., a (e.g., an identification) code/number) such as a) a serial number of a device, b) a unique code/number defined/assigned to a device manually (e.g., by a user controlling the controlling server (e.g., by a corresponding admin)), c) a unique code/number automatically (e.g., randomly/arbitrarily, by a/the corresponding controlling application) assigned to a device, d) etc. Said ID number may be registered in (e.g., a corresponding table of) a/the corresponding controlling account/server, preferably, during creation and/or modification of a controlling account. Preferably, said ID number (e.g., or a number/code generated based on said ID number) may be available/stored within the corresponding device, as well. As an example, the controlling application running within a (e.g., main) device may have/control the ID number of said (e.g., main device).

According to one aspect, by considering the exemplary controlling server 1019 of FIG. 6A, when an admin of a controlling account 6010 proceeds to create said controlling account within a corresponding controlling server (e.g., 1019), the corresponding server 1019 may install a version of the controlling application that corresponds/is adapted to a (e.g., corresponding) device (e.g., a main device 1001, an intermediate device 1002) being introduced by the admin to the server. The controlling server 1019 may assign a unique ID number (e.g. 1001 to the main device, 1002 to the intermediate device) to said device and include said ID number within the installed version. The controlling server may also memorize/write said ID number in a corresponding field 1017 (e.g., in this example, the respective field 1017 and 1018) within the controlling account. This procedure may be applied/repeated for each of the devices (e.g., a main device, an intermediate device, etc.) of the/a corresponding authentication circuit. Note that an ID number can be-comprised-of/include any number of plurality of characters and/or any number of plurality of types of characters and/or any binary code, etc.

Preferably, transmission of a security code from one device (e.g., intermediate device) to another device (e.g., main device) is made after executing a procedure (e.g. herein may be referred to as “identifying procedure”) for verifying/identifying the exactitude the ID number of said another device (e.g., the main device). According to a preferred embodiment, before redirecting a/the received (e.g., encrypted) security code to the/a main device, (e.g., the controlling application installed within) the intermediate device may preferably, verify the exactitude of/identifying the main device's ID number (e.g., by (e.g., requesting and) receiving the ID number of the main device (e.g., directly from the main device or through the corresponding controlling server, etc.)) and matching said ID number to the corresponding ID number registered in the corresponding account server). As an example, when a user approaches an intermediate device to the main device, upon availability/establishment of the (e.g., short range) communication between said two devices, the main device may transmit its ID number to the intermediate device to the intermediate device. Then (e.g., the controlling application running within) the intermediate device, may either locally (e.g., by comparing said ID number received from the main device with a corresponding ID number locally stored in the intermediate device), or remotely (e.g., by comparing said ID number received from the main device with a corresponding ID number stored in the corresponding controlling account/server) compare the received ID number with the ID number stored in the intermediate device and/or in the corresponding controlling account/server. If the ID numbers are found to be identical, (e.g., herein may be referred to as being “matched/identified”) (e.g., only) then/thereafter, the intermediate device may transmit the/a corresponding (e.g., encrypted) security code (e.g., received from a/the account server) to the main device, otherwise, the intermediate device does not transmit the/a corresponding (e.g., encrypted) security code (e.g., received from a/the server) to the main device.

It must be noted that, any other method of assigning-to and/or using a unique ID number of a first device (e.g., a main device) may be used with the principles of a procedure for transmitting a security code from a second device (e.g., an intermediate device) to said first device (e.g., to said main device).

It is understood that, preferably, procedure of transferring information such as an/the ID number and/or a/the security code from one device to another device is preferably authorized through a short range communication system between said devices. As such, preferably, said information is transfer between the said devices after said devices are approached to each other in a manner that transfer of said information becomes possible/effective through their corresponding short range communication system means/systems. As an example, an identifying procedure of a first (e.g., main) device by a second (e.g., intermediate) device and procedure of transfer of a corresponding security code from said second device to the first device (e.g., said procedures, together, herein may be referred to as “identifying and transferring procedure”) may preferably become possible/effective/permitted when said devices are approached/closed to each other such that transfer of information through their corresponding Near Field Communication means/systems becomes possible.

It must be noted that during an entire identifying and/or transferring procedure (e.g., authentication procedure) said (e.g., intermediate and main) devices may preferably be kept approached/closed to each other and/or said short range communication should not be interrupted, otherwise, said procedure is preferably canceled (e.g., is considered unaccomplished). In this case, according to one method, said procedure should be repeated from scratch/beginning. This is because the authentication system must make sure that the identified device is the one that the security code will be transmitted to. As an example, after (e.g. said devices being approached to each other), if said devices get far from each other, said authentication procedure is canceled.

According to one aspect of the invention, the transmission of the (e.g., encrypted) security code (e.g., from intermediate device) to the main device may be executed (e.g., indirectly) through an additional means/device (e.g., the controlling server), while according to a preferred aspect the transmission of the (e.g., encrypted) security code to the main device may be executed (e.g., directly) without the use of an additional means/device.

With continuous description of the invention, FIGS. 6B and 6C show as an example, a user of a main device 1001 (e.g., a smartphone) and an intermediate device 1002 (e.g., a smartwatch) e.g., within/of a corresponding authentication circuit) attempting to log in into his/her account within an account sever 1009. As such, after receiving a corresponding username from the main device 1001, the account server may send 1005 a (e.g., an encrypted) security code to the intermediate device 1002. At this time, different methods may be considered:

a) according to a first method, as shown in FIG. 6B, if a short communication connection is established between said intermediate device 1002 and the main device 1001, the main device 1001 may transmit 10061 its ID number to the intermediate device 1002. The intermediate device 1002, then, may proceed to an identifying procedure (e.g., as described above (e.g., by sending/transmitting the received ID number to the controlling server for identification process)) upon/after which (e.g., if the main device is identified) the intermediate device 1002 may (e.g., become authorized by the controlling server to) send the security code to the main device, otherwise (e.g., if the main device is not identified), the intermediate device may not (e.g., become authorized by the controlling server to) send the security code to the main device.

b) according to a second method, as shown in FIG. 6C, if a short communication connection is established between said intermediate device 1002 and the main device 1001, the main device 1001 may transmit 10062 its ID number to the controlling server 1019. The controlling server 1019, then, may proceed to an identifying procedure (e.g., as described above) upon/after which, if the main device 1001 is identified, the controlling server may authorize the intermediate device 1002 to send/transmit the security code to the main device 1001, otherwise (e.g., if the main device 1001 is not identified) the intermediate device 1002 may not (e.g., become authorized by the controlling server 1019 to) send/transmit the security code to the main device 1001. Note that optionally, the ID number of the main device 1001 may be transmitted to the controlling server indirectly, such as through the intermediate device 1002. Note that as described throughout this patent application, the corresponding encryption key is preferably sent by the account server 1009 to the main device 1001.

According to one embodiment of the invention, during a sign-in/registration procedure for opening an account within an account server, a user may be required to provide only one telephone number (e.g., that of an intermediate device). In this case, the user may preferably provide the telephone number of an/the corresponding intermediate device of a corresponding authentication circuit. In this case, the decryption key may be transmitted from the account server to the main device for example through Internet.

According to the current embodiment, no modification (e.g., in the interface of an account server) in a/the current procedures of sign-in and/or log-in into the account servers may be required. As shown in FIG. 6B, accordingly, a username (e.g., an email address), a password, and a telephone number (e.g., provided (e.g., earlier/initially) by a user during a sign-in/registration procedure) may be enough for an account server 1009 for permitting a secure log-in into said server in general, and a user name and a single telephone number may be enough for an account server 1009 for permitting a secure log-in into said server through an/the authentication procedure of the invention in particular. Note that other existing or non-existing procedures of assigning-to and/or using-of a unique ID number of a device for identifying purpose, and/or other existing or non-existing identifying procedure may be considered by people skilled in the art.

The above-mentioned explanation regarding columns 1, to 6, can be applied to any of the rows of a/the table (e.g., each row corresponding to different device of the/an authentication circuit). Note that, a (e.g. an intermediate, main, etc.) device can be deleted or added to an authentication circuit. If a device is (e.g., desired to) be added to authentication circuit, a corresponding new row is preferably added (e.g. by a corresponding admin/user) in a corresponding controlling table (e.g. 6010).

According to one example, when an admin/user of a controlling account executes a signs-in procedure within an account server for creating said/a account, he/she may preferably enter at least a/the contact information 6019 of the device represented by the first row of a corresponding table (in this example, the telephone number of the intermediate device 1002). As such, every time afterwards, that a user of the main device 1001 attempts to log in to said protected account in said account server, the account server may preferably send a corresponding security code (e.g., preferably, via SMS) to said device (e.g., 1002) by using said contact information (e.g., the telephone number). If said security code is encrypted, then, as mentioned before, a key for decrypting said security code is simultaneously sent by the account server to the main device 1001 (e.g., by using the contact information (e.g., IP address) of the main device 1001 or by using the telephone number 6018 of the main device 1001, (e.g., if provided during said sign-in procedure, etc.).

Preferably, the controlling parameters are controlled/managed by a user authorized to access a corresponding controlling account (e.g., an admin). As an example, said user may make modifications to the parameters (e.g., within a/the table) stored within said controlling account to make changes to the behavior of a (e.g., one or more devices) of a corresponding authentication circuit. As an example, an admin of a controlling account may preferably have the ability, to pause, disable or remove any of the intermediate devices in or from the authentication circuit, through a predefined action such as by making corresponding changes within the parameters (e.g., within the controlling table).

Optionally, the behavior of a (e.g., one or more devices) of an authentication circuit may be controlled by another device (e.g., of the authentication circuit). According to one aspect, a user controlling the main device 1001 may request a user of another device within an authentication circuit to disable his/her device within the authentication circuit (e.g., to pause or disable his/her device of doing an (e.g. any) action within the authentication circuit). According to another aspect, the user controlling a main device may preferably have the ability (e.g., through an application controlling the corresponding authentication circuit) to pause, disable or remove any intermediate device in or from the authentication circuit.

As mentioned, the intermediate device (e.g., in this example, 1002) represented by/in the first row of the table 6010, is preferably, the device to which an account server within an authentication circuit sends 1005 a/the security code as described herein, preferably through an SMS application. After receiving the security code by the intermediate device (e.g., in this example, 1002), said security code is sent/transmitted 1006 to the following active device represented by a following horizontal row of the table. In this example, said device is 1001.

In this example, the security code received (e.g., by the SMS application of the device 1002) from the account server (e.g., 1009), is preferably captured/intercepted by the/a controlling application of the invention running within the device 1002 (e.g., from the SMS application of the device 1002). Then, according to one aspect of the invention, said controlling application executes a process for sending said security code (e.g., automatically) (e.g., through the SMS application of said device 1002), to the next active device 1001 represented by a following horizontal row of the table.

A controlling account may have/hold more than one controlling tables, each corresponding to a different authentication circuit/procedure. As an example, in a single controlling account, a user may create a first controlling circuit/account for accessing a high-sensitive protected account, and create a second circuit for accessing a low-sensitive protected account.

According to one aspect, when a user/admin attempts to log in to the controlling server and/or attempts to change/modify a parameter within a controlling account, the controlling server and/or the controlling account may preferably send a notification (e.g., an alert) message to at least one, preferably all/both (e.g., the main and the intermediate) of the devices of a corresponding authentication circuit. Preferably, (e.g., the user of) at-least-one/each of the devices is required/requested to respond to said notification message by, for example, sending a predefined message to the controlling server so that to authorize said log in to the controlling server and/or said modification.

It is important to note that examples of telecommunication (e.g., herein may be referred to as “communication”) technologies (e.g., SMS for long-range, NFC, for short-range), for transmitting of a security code from one device to another device in an authentication circuit, are used as an example to describe the principles of the authentication procedures of the invention. It is understood that any selected/predefined communication technology (e.g., Internet, cellular, Wi-Fi, etc., for the long-range, Bluetooth, NFC, etc., for the short-range), may be used for the same purpose.

Note that according to one method, a/the controlling application running within a device (e.g., intermediate device 1002) may preferably be in charge of receiving/capturing a/said security code (e.g., sent from an account server 1009 to said intermediate device 1002), and, thereafter, communicating and/or interacting with a corresponding controlling server 1019, and sending/redirecting said security code (e.g., through a selected/authorized communication technology (e.g., NFC)) to another device (e.g., 1001), etc.

A controlling server may include a plurality/many controlling accounts each managed/owned by an (e.g. a different and/or a same) admin of a corresponding controlling account.

A controlling server may include a plurality of controlling accounts wherein preferably each of at least some of said controlling accounts corresponding to a different controlling circuit/account and/or a different controlling application.

Access to a different controlling account is/may-be permitted by providing a (e.g. different) corresponding log in information (e.g., provided earlier/previously by an admin of said controlling account during a corresponding sign-in procedure).

According to one embodiment, a first controlling table may be used by a corresponding authentication circuit/procedure for logging in to a first protected account within a first account server, and a second controlling table may be used by a corresponding authentication circuit/procedure for logging in to a second protected account within said first account server or within a second account server. As an example, a first controlling table may be used for logging in to a bank protected account within a corresponding account server, and a second controlling table may be used by a corresponding authentication circuit/procedure for logging in to a user;s account within a media/shopping store.

Preferably, each of the controlling tables may be related to a corresponding protected account within a same or within a different account server.

Note that, the controlling application using a controlling account having an interface (e.g. in form of a table) including some (e.g. one or more) parameters, are described and shown as an example, for describing the gist/principles of the invention. Any other type of application using a controlling account having any type of (e.g. interface of) parameters for controlling the execution of an authentication procedure may be defined by people skilled in the art.

With continuous description of the current embodiment, the exemplary FIG. 6D shows that at some point/moment/instance, the admin of the controlling account has accessed the controlling account and the corresponding table 6010, and has disabled/unauthorized (e.g. by switching the corresponding button 6011 from “On/active” status to “Off/non-active” status) the device 1002 from sending/transmitting information (e.g., a security code) received from an account server (e.g., 1009) to the/a next (e.g. main) device 1001. As an example, if the owner of the main device, notices that the main device 1001 and/or the intermediate device 1002, is/are being lost and/or stolen, said user may disable/unauthorize the intermediate device 1002 to send/transmit a security code received from the account server 1009, to the lost and/or stolen main device 1001. In this case, the authentication procedure cannot be completed, therefore, a person possessing the lost/stolen main device 1001 cannot access (any of) the user's protected accounts.

As mentioned before, an intermediate device may have, both, short-range transmission technology and long-range transmission technology. According to one embodiment of the invention, an admin of a controlling account within a controlling server may define and/or modify a (e.g., one or more) definition/parameter of transmission of information (e.g., a security code) from a first (e.g., an intermediate) device to a second (e.g., a main) device (e.g., within a corresponding table) in the controlling account. As an example, by considering the authentication circuit of FIG. 6A, in some situations/conditions, the intermediate device 1002 may be far from the main device 1001. Accordingly, successfully transmission of a received security code by the intermediate device 1002 to the main device 1001 (e.g., automatically) becomes interrupted/impossible because of the distance between said devices (e.g., said distance being longer than the transmission range of the short-range transmission technology of the intermediate device). As such, as shown in FIG. 6E, an admin of the/a corresponding controlling account may access to said controlling account within a corresponding server and modify the corresponding parameter within the controlling table 6010 by changing the corresponding transmission parameter 6021 from short-range to long-range. Accordingly, the intermediate device 1002 may preferably become permitted to transmit/redirect 1006 a security code (e.g., received from the account server 1009), to the main device 1001 through a long-range transmitter of said intermediate device 1002. In this case, the user of the main device may access a (e.g., his/her) desired protected account even if the intermediate device 1002 is far from the main device 1001.

With continuous description of the current embodiment, if said protected account is a high-sensitive protected account then, preferably, before switching the transmission parameter 6021 of the intermediate device 1002 to ‘long-range” for accessing a protected account, said user may preferably make sure that the intermediate device is safe to use (e.g., is not stolen, lost, etc.). Preferably, after the security code is transmitted, said parameter 6021 may be automatically switched back to “short” range transmission.

With continuous description of the current embodiment, according to a preferred aspect, upon accomplishment of a condition (e.g., such as at least one of, when the corresponding log in authentication circuit/procedure is accomplished, after a predefined (short) amount of time, immediately after the intermediate device 1002 redirects/sends/transmits a (e.g., received) security code to the following device 1001, immediately after the controlling application running within the intermediate device is given a permission by the controlling account (e.g., according to a preferred aspect, after an/the (encrypted) security code is received by the/an intermediate device 1002, the controlling application running within the/an intermediate device 1002 may preferably, proceed-to/execute a procedure to find out whether the intermediate device is permitted to transfer/transmit the received (encrypted) security code to the/a next (e.g., main) device 1001, by accessing the/a corresponding parameter in the controlling account within the controlling server. After identifying the approval of permission (e.g., if the corresponding parameter approves the/such permission), the intermediate device is authorized to transmit the (encrypted) security code to the main device 1001). Such procedure resulting in identifying a/the transmission permission approval may herein be referred to as “identifying (e.g., a corresponding) transmission (e.g., permission) approval”), to send said information (e.g., the said security code), using a long-range transmitter, to another device, etc.), the corresponding parameter 6021 is preferably automatically switched back (e.g., by the controlling server or by a corresponding controlling application, etc.) to “short-range”.

An admin of a controlling account may define (e.g., create) at least two types of controlling table for an (e.g. a single) authentication circuit. In the exemplary FIG. 6F, an interface 6400 of a controlling account having two types of controlling tables is shown. A first controlling table 6010 in which a transmission range parameter of a (e.g., an/the intermediate) device is set to “short-range” (e.g., herein may be referred to as a “high-sensitive table”) may be defined/used for accessing a high-sensitive protected account, and a second controlling table 6020 in which a transmission range parameter of a (e.g., an/the intermediate) device is set to “long-range” (e.g., herein may be referred to as a “low-sensitive table”) may be defined for accessing a low-sensitive protected account.

According to one embodiment, said admin of the corresponding controlling account (or any other authorized physical or virtual (e.g. a software) entity having an access control to said controlling account) may select a desired table among said tables before attempting to log in to a protected account. A switching feature 6401 adapted to activate a first table among said tables may be used by said admin (or vise versa). As such, the second table may become deactivated (or vise versa). When a user attempts to access/log in to a desired protected account, the selected/activated controlling table is (e.g., automatically) used by the corresponding controlling application during an authentication circuit/procedure.

According to a preferred embodiment, as shown in FIG. 6A, preferably, the controlling account has one controlling table (e.g., 6010) in which, preferably by default, the transmission range parameter of the intermediate device (e.g. 1002) is in (e.g., set to) “short-range” status, therefore, the log in procedure to a (e.g., any) protected account is preferably controlled based-on/by a/the high-sensitive table 6010, unless otherwise (e.g. low-sensitive controlling table/procedure) is desired/selected for the logging-in-to/accessing a desired protected account (e.g. at a specific moment). In this case, as shown in FIG. 6E, before attempting to log in to said protected account, the user may access the controlling account within the/a corresponding controlling server and change the transmission range parameter of the intermediate device (e.g. 1002) within said table (e.g., 6010) to “long-range” status.

With continuous description of the current embodiment, for security purpose, according to one aspect, preferably, said controlling table may preferably (e.g., automatically) immediately switch back to high-sensitive status after a corresponding low-sensitive (e.g. above-mentioned/latter) cycle of the authentication circuit is accomplished/completed. Alternatively or in addition to said aspect, said table may preferably automatically switch back to high-sensitive status, a predefined lapse of time after being switched to low-sensitive status.

It is understood, that other systems and/or methods of, creating, selecting, controlling, etc., a high-sensitive or low-sensitive authentication circuit and/or authentication procedure may be considered by people skilled in the art in accordance with the principles of authentication procedures of the current invention. As an example, the/a controlling account may have both, a high-sensitive and a low-sensitive controlling tables as shown in FIG. 6F. Preferably, by default, the high-sensitive table is active/selected (i.e., the corresponding authentication circuit is controlled by the high-sensitive table), unless an admin of the controlling server (e.g. the user of the main device) deactivates the high-sensitive controlling table and activates the low-sensitive controlling table. And vise versa.

According to one embodiment, a controlling application may be executed within a controlling server. According to one aspect, the controlling server may be a remote device (e.g., in a cloud). According to another aspect, the controlling server may be the main device (e.g., or another device) of an authentication circuit.

A controlling application and/or the authentication circuit may preferably include/use a (e.g., its own) messaging software/application in which a message (e.g., a security code) sent by a first device (e.g., through a version of a corresponding messaging software running (e.g., in the background and/or in the foreground) within said first device to a second device within the corresponding authentication circuit, is intercepted by (e.g., a version of the corresponding messaging software running (e.g., in the background and/or in the foreground) within said second device. And. So on. According to one embodiment, said messaging application may be part-of/included-within and/or work-with the controlling application of the invention. Optionally, said messaging application may work independently from the controlling application but preferably interacts with (e.g., receives and/or sends information/content, respectively, from and/or to) a/the controlling application of the invention.

A controlling application may have different versions wherein each different version is adapted to run (e.g., preferably in the background) within a specific/different/dedicated device within/of an authentication circuit. Alternatively, a same version may be adapted to run (e.g., preferably in the background) within any (e.g., and all) of the devices of an authentication circuit. A controlling application may be installed and run within at least one or more (e.g. preferably, all) of the devices of an authentication circuit (e.g., said devices communicating with each other, preferably though said controlling application/s running within said at least one or more or all of said device/s), together, forming a communication network.

A controlling application running within a main device may execute some task/s different than some tasks executed by a controlling application running within an intermediate device. As an example, a controlling application running within an intermediate device, may have some tasks such as intercepting a (e.g. an encrypted) security code sent by another device (e.g., by an account server) to said intermediate device, (e.g., and if required, re-encrypting said security code), sending a permission request to the controlling server (e.g., or accessing the controlling account within the controlling server for verifying the transmission permission status of the intermediate device), and, if permitted, redirecting the security code to the following device (e.g., a main device), etc. Also an example, a controlling application running within a main device, may have some tasks such as intercepting a (e.g. an encrypted) security code sent by/transmitted from another (e.g., an intermediate) device to said main device, sending a permission request for decrypting said security code to the controlling server, (e.g., if permitted, decrypting said security code), etc.

As mentioned, an authentication system/circuit preferably has/uses a controlling server/account for controlling the behavior of devices of an (e.g., a corresponding) authentication circuit. As an example, by considering authentication circuit 1000 and the controlling table 6010 of FIG. 6A, after a security code, sent 1004 by the account server 1009 (e.g., the account server to which the user wants to log in to his/her protected account), is received by the intermediate device 1002 (e.g., by SMS system or by another communication technology) and intercepted by a (e.g., version of a) controlling application of the invention running within the intermediate device 1002, the intermediate device 1002 may send/redirect/transmit 1006 said security code (e.g., or another security code based on said security code) by using a short-range transmitting technology (e.g., short-range transmitter/NFC) to the main device 1001, (e.g., through the messaging application of the invention). Alternatively, all of the authentication circuit devices, including the corresponding account server, use a same controlling/messaging application for sending/transmitting a message (e.g. a security code) from one device to another device. Preferably, said messaging application is a proprietary application of the authentication circuit of the invention and is controlled by the authentication circuit of the invention.

As mentioned, each device of the authentication circuit may preferably have an (e.g. a unique) identification information (e.g., ID) (e.g. an identification number (e.g. 1002, 1001, a serial number of the device, a permanent IP address, a telephone number, etc.), a contact information (e.g., a unique address/means (e.g., a telephone number, a (e.g., permanent) IP address, etc.))) based on which (e.g., among other conditions) sending and/or receiving secured information (e.g., security code) from one device to another device becomes/is effective/possible/authorized.

According to one embodiment of the invention, by considering the exemplary FIG. 6A, when an intermediate device (e.g., 1002) receives a message (e.g., security code) from an account server (1009), a controlling application running within said intermediate device may intercept said security code and notify/access 6029 the controlling server 1019 containing a controlling account used by the controlling application. Based on the status of a/the corresponding controlling table 6010, the controlling server 1019 may preferably transmit/send 6022 some (e.g., one or more) parameters/information (e.g., hereafter may be referred to as a “permission status information/procedure”) to the intermediate device based on which the intermediate device executes some process/es. Said parameters may preferably at least include one of the following:
1) If/whether the intermediate device is permitted (e.g., “Active”) (e.g., or not permitted) to send said security code to a following device;
2) Which type of transmitter to use (Short-range or Long-range);
3) The contact information/address/unique ID of the following device;
4) Etc.

After getting a permission from the controlling server 1019, the intermediate device 1002 may preferably be authorized to send/transmit 1006 said security code (e.g., or another security code based on said security code) to the main device 1001. After receiving the security code from the intermediate device 1002 (e.g., and decrypting it), the main device 1001 may send 1007 the (e.g., decrypted) security code to the account server 1009. The account server 1009 may preferably verify (e.g., compare the received security code from the main device 1001 with the (e.g., original) security code (e.g., before it was encrypted and sent to the intermediate device 1002) (e.g., herein may be referred to as “original security code” or “unencrypted security code”) and upon validating/matching/identifying said received security code (e.g., to the original security code), the account server 1009 gives (e.g., permission to the main device 1001 to) access into a corresponding protected account (e.g., The log in circuit/procedure is successfully completed).

According to one embodiment, a permission from the controlling server (e.g., 1009) is required for the controlling application running within the main device (e.g., 1001) for decrypting said/an encrypted security code (e.g., a parameter within a corresponding controlling account (e.g., table) may be created (e.g., and, if needed, can be updated/modified) in this regard, by an admin of a/the controlling server). As such, after the main device receives an encrypted security code from an intermediate device, the main device may preferably send a permission request to the controlling server in this regard. Then, upon receiving a permission from the controlling server, said controlling application running within the main device (e.g. or another software) may decrypt said security code.

According to a preferred aspect, the decryption software installed on the main device is provided by and/or is owned-by/a-proprietary-of a corresponding account server and/or is controlled by the account server. Preferably, said decryption software is (e.g., downloaded and) installed within the main device by an account server's installation software or from an application store such as Apple Store, Google's Play Store, etc. Optionally, the decryption software is provided by and/or is a proprietary of an entity other than said corresponding account server. Optionally, the decryption software is provided by and/or is part of a the/a controlling application of the invention (e.g., installed/executed on a main device) using a/the received decryption key for decrypting the/an encrypted security code (e.g., received from the/an account server by an/the main device).

According to one aspect, an encrypted security code received by an intermediate device (e.g. 1002), may preferably be encrypted again, by the controlling application running within said device by using a second (e.g., predefined) encryption key/code, to provide another (e.g. a new) encrypted security code with stronger encryption. This procedure may be repeated by one or more additional (e.g., if any) intermediate devices, each preferably using a different (e.g., predefined) encryption key/code. In addition to the decrypting key received from the account server, one or more decryption key/s used for decrypting for the latter encrypted security code/s may (e.g., predefinely) be available within the main device and may be used by a decryption software (e.g., of/used-by the controlling application or by the account server, etc.) running within a/the main device (e.g., 1001) for decrypting said latter encrypted security code/s. When a main device receives said encrypted security code from an intermediate device, said main device may use the decrypting key received from the protected account server and a (e.g., one or more) decrypting key/s corresponding to decryption made by a (e.g., one or more) intermediate device/s to decrypt the said security code.

After the accomplishment of the decryption procedure, the decrypted security code is sent/transmitted to the account server. According to a preferred aspect, the decrypted security code is displayed on the screen of the main device, and the user is required to manually enter/type said security code in a dedicated (e.g., text) field displayed on the screen of the main device and (e.g., and press on a Send key to) send it to the account server. Optionally, after entering the decrypted security code by a user, the system automatically transmits the encrypted security code to the account server. Alternatively (e.g., after decryption), said security code is automatically sent to the account server by the main device.

According to another embodiment, a controlling application running within a (e.g., an intermediate) device may have its own controlling parameters/table located locally within said device. Said controlling parameters/table may preferably be updated by the controlling server (e.g., each time a corresponding table within a controlling server is modified/updated). As such the controlling application may execute a function (e.g., to send or not sent a received message/security code to another device) based on said/its own parameters/table located/stored in the intermediate device. As such, every time a controlling table is created and/or modified, each of the relevant controlling applications installed within an intermediate device may automatically (e.g., locally) be updated. In this case, getting permission from the controlling server is not needed by an intermediate device when receiving a security code. Same principles may be applied to the main device as well.

As mentioned before, an authentication circuit may have one or more additional intermediate devices. FIG. 6G, shows an authentication circuit with two intermediate devices 1003 and 1002. Accordingly, a corresponding controlling table 6030 in high-sensitive status (e.g., the authorized transmission range 6501 within the authentication circuit by the intermediate device 1002 is set to “Short”) is created within a corresponding controlling server. In order to switch said table to a low-sensitive status, the admin of an account within the controlling server may change the range of device from “short” 6501 to “long”.

Sign-in procedure for creating an account in an account server is known by people skilled in the art and/or by the general public. As an example, a user may be required to (e.g., create and) provide some information such as a user's identification information (e.g., a username), a password and a contact information (e.g., a telephone number, an email address, etc.) for sending a security code to that telephone (e.g., number) by the account server each time a user attempts to access said/his/her account (e.g. herein may be referred to as a log-in procedure).

According to one embodiment of the invention, for creating an account within an account server, a user (e.g., an admin) may first successfully accomplish a sign-in procedure in said account server. The sign-in procedure may preferably be similar to the sign-in procedure described above with the difference that in the sign-in procedure of the invention, a user may provide at least the contact information of an/the intermediate device and the contact information of a/the main device. As an example, the user may first open a sign-in webpage of a desired website/account server in a browser. The corresponding account server may require a list of user's information such as:
1. A username (An account identification information such as a user's arbitrary/desired text such as his/her email, telephone number, an ID, etc.)
2. A password;
3. A contact information (e.g. a telephone number) of an intermediate device for sending a (e.g., an encrypted) security code by the account server during a log in procedure;
4. A contact information (e.g. a telephone number) of a main device for enabling the account server to send, a key for decrypting said encrypted security code, to the main device;
5. Etc.

The user, then, sends (e.g., by pressing a corresponding send button) said information to the account server (e.g., via a communication system such as Internet, Wi-Fi, cellular, etc.). The account server stores said information within (e.g., an entry of a database of) said account server.

The sign-in procedure is accomplished. Note that in some cases, such as account within a bank server, the username may be defined by the account (e.g., bank) server.

### Log in Procedure for Accessing an Already Registered Protected Account

Below are exemplary steps for logging in to an already registered/signed-in to protected account (e.g., said protected account) within an/said account server:
1. A user controlling said/a main device, may first open a log in webpage/interface of a corresponding website/account server on a/his/her device (e.g., the main device);
2. The user enters the corresponding protected account identification information (e.g., the username) (e.g., said user's arbitrary/desired text, which was provided during the sign-in procedure, and sends (e.g., by pressing a corresponding button) said information to the account server (e.g., via a communication protocol/technology such an Internet, Wi-Fi, cellular, etc.)
3. The account server compares the received identification information with the corresponding identification information stored within (e.g., the entries of said database of) said account server. After successfully matching said identification information with an/the identification information (e.g., stored (e.g., within an entry of said database), the account server sends (e.g., by SMS) a (e.g. an encrypted) security code to the intermediate device according to a corresponding contact information (e.g. the telephone number) of said intermediate device stored in the (e.g., protected account of the) account server.

If the security code is encrypted, the protected account sever may, preferably simultaneously, send (e.g., by SMS, by email, etc.) a key for decrypting said encrypted security code to the user's main device according to the contact information (e.g. the telephone number, email, etc.) of said main device stored in said account server.
4. after receiving said (e.g., encrypted) security code, by said intermediate device, from the account server, if said intermediate device is active (e.g., authorized by the controlling application), the intermediate device sends/redirects said (e.g., encrypted) security code (e.g., by for example, a Near Field Communication (NFC) system (e.g., if the device is defined to use a short-range communication system/transmission system), or otherwise, (e.g., if the device is defined to use a long-range communication system/transmission) by a long-range communication system) to the following device as defined in the corresponding controlling table of the corresponding controlling sever. According to a preferred scenario, said following device is the main device. According to another scenario, said following device is another intermediate device. In this case, Step 4 is preferably repeated until the following device is a main device.
5. According to one aspect, after receiving said (e.g., encrypted) security code, by the main device, said (encrypted) security code (e.g., is decrypted by using said decryption key through a decrypting software (e.g. of the controlling application, of the account server, etc.), preferably, locally within the main device, and):

Option (a) is automatically sent to the account server.

Option (b) is, manually, entered (e.g., by type action/by copy-and-paste action) within a predefined input field (e.g., text field) of a log in interface of the account server displayed on the screen of the main device (e.g. within a browser).

Preferably, the encrypted security code is decrypted by a software of the account server (e.g. a bank account server), (e.g., installed and) running (e.g., in background) within a corresponding device (e.g., the device in which the decryption procedure is executed, (e.g., in the main device)). Optionally, if the decryption procedure is executed in the/an intermediate device, then, accordingly/preferably, the encrypted security code is decrypted by a software of/related-to the account server (e.g. a bank account server), (e.g., installed and) running (e.g., in background) within the intermediate device. In-general/preferably, the encrypted security code is (e.g., automatically) provided to the/said software through an API (e.g., of/related-to said software of/related-to the account server). Optionally, said software of/related-to the account server may perceive/retrieve the encrypted security code from/through an API of the controlling application running within the corresponding device (e.g., in which the decryption procedure is executed).

At this time (e.g., after matching, by the account server, the security code received from the main device to the security code sent by said account server to the intermediate device), the authentication procedure is completed and the user of the main device is preferably given access (e.g., by the account server), to the desired protected account (e.g., preferably on the main device).

The steps described above are provided as an example. Other methods of logging in to a protected account may be considered by people skilled in the art, without deriving from the principles of the current invention/application.

If for some reason a user desires to use another device as a main device (e.g., a user changes his/her main device to a new device, uses temporarily another (main) device, etc.) for accessing a protected account, the admin of the controlling account (e.g. said user) may:

a) Replace the contact information (e.g., the telephone number, serial number) of the main device in the corresponding controlling account. As an example, in the exemplary authentication circuit of FIG. 1A, if the laptop 1001 is to be replaced by another main device (e.g., a smartphone), then as shown in FIG. 6H, the admin of the corresponding controlling account may modify the corresponding information in the corresponding field 6201 of the controlling table 6010. In this example, the contact information (e.g., the telephone number) of the laptop 1001 is replaced by the contact information (e.g., the telephone number) of the smartphone 1101 in the corresponding field 6201 of the intermediate device 1002 by an admin of the controlling account.

b) Optionally, as shown in exemplary FIG. 6I, the/corresponding contact information (e.g., the telephone number) of the main device in the corresponding (e.g., account in the) account server is automatically updated (e.g., by the controlling server sending 6202 said contact information to the account server.

Alternatively, the user (e.g., the owner of the account) may log in the corresponding account in the account server and modify said/the contact information of the main device.

It must be noted that, a main device (e.g., a laptop, a smartphone, etc.) and/or an account server in an authentication circuit, may not have/use a telephone number. Although in this patent application, in an exemplary controlling table, a telephone number is indicated/shown as a contact information for transmitting a security code from one device (e.g., or from an account server) to another device, it is understood that said type of contact information is indicated/shown as an example for describing the gist of the invention. Other methods of communication may be used for transmitting a security code from one device (e.g., or from an account server) to another device. For such purpose, variety of communication means/technologies are available and known in the communication industry and/or known by people skilled in the art.

Note that the controlling server may preferably be a remote/cloud server. Optionally, the controlling server may be a device of the authentication circuit, preferably, the main device.

Note that the controlling application of the invention may be a (e.g., complex) software having many parts related to and/or communicating with each other. Preferably, the main part of the controlling application may preferably run within the main device and/or within the controlling server. A derivative/portion of said application/software may be installed and run within an (e.g., one or more) intermediate device.

According to one embodiment, as shown in the exemplary FIG. 6J, instead of using a controlling server, the controlling application may use a memory space within/related-to a (e.ge., each) user's protected account within a/the corresponding account server (e.g., in this example, 1009). As such, a memory space within said account server may be dedicated to the information (e.g., parameters, a/the table 6010) of the controlling application of the invention.

According to one embodiment, the decryption procedure is executed by the account server 1009. In this case, according to one method, a security code received by the main device from an intermediate device, is sent, as is, by the main device to the account server 1009. According to another method, a decryption software controlled by an/the account server and installed on a/the main device, may execute the decryption procedure using the decryption key received from an/the account server.

Note that the communication (e.g., transmission of information) between, at least, a main device and a server (e.g., and/or vise-versa), such as a log in attempt within/to a protected account within an account server may preferably be through Internet (e.g., by using an IP address of the main device and the account server).

The principles of the authentication procedure of the invention are generally relied/based on using an authentication circuit having a main device, (e.g. at least) one intermediate device and a controlling server to authenticate a user for executing a function such as accessing a user's account in an account server.

According to said principles, upon a request, for permitting access to an account, provided by the main device to the account server, the account server sends a (e.g., an encrypted) security code to the main device and a decryption key to the intermediate device (e.g., or vise versa). Then, by approaching said main device and the intermediate device, an identifying procedure in executed through/using the controlling server during/in which at least a specific device among said two devices is identified. After approval of the identity (e.g., by the controlling server), the security code is sent from one (e.g., intermediate) device to another (e.g., main) device to be decrypted. After decryption, the decrypted security code will be sent from the main device to the account server, which thereafter, preferably, executes the corresponding function (e.g., gives access to a corresponding user's account, opens a door, turns on a machine, etc.).

Based on principles as described herein, several other methods of authentication procedure may be considered by people skilled in the art. FIG. 6K shows, as an example, another authentication method. In this example, a user controlling the main device 1001 sends 6071, through said main device, a request for accessing (e.g. logging into) his/her account within a corresponding account server 1009. Upon receiving said request, the account server 1009 sends 6072 an (e.g., encrypted) security code to the intermediate device 1002 and also sends 6073 a decryption key to the main device 1001. After approaching the intermediate device 1002 and the main device 1001, the/a (e.g., unique) ID number of/related to the intermediate device is received/captured 6074 (e.g. through a short range communication system such as NFC) by the main device 1001 (e.g., from the intermediate device). Thereafter, the main device 1001 may send 6075 the received ID number of the intermediate device 1002 and (e.g. together with) the ID number of the main device 1001 (e.g., together may be referred to as “combined information) to the controlling server 1019. After successfully identifying (e.g., matching) the ID numbers of the main and intermediate device with/to the corresponding ID numbers registered in the/a corresponding controlling account 6010 (e.g., within the controlling server 1019), the an authorization procedure/notice is executed (e.g., the intermediate device accesses the controlling server and the controlling server sends 6076 an authorization status/message/notification to the intermediate device 1002) upon/based-on which (e.g., if intermediate device is authorized) the intermediate device 1002 sends/transfers 6077 (e.g., preferably through a short-range communication system (e.g., NFC), optionally (e.g., if the intermediate device does not have a NFC transmission capability/means), through a long-range communication system (e.g., Bluetooth/Wifi/cellular/infrared/etc.)) the encrypted security code to the main device 1001. According to one method, said encrypted security code is sent/transmitted/transferred automatically to the main device 1001 (e.g., by the intermediate device 1002). Optionally, said security code is sent/transmitted/transferred to the main device upon a predefined interaction provided by the/a user controlling the intermediate device 1002 such as pressing a (e.g., a “send”) key presented to the user on (e.g., the screen of) said intermediate device 1002 upon/after receiving/getting said authorization. Note that in the example above, optionally, the ID number of the main device may be transferred to the intermediate device and the combined information may then be identified through the intermediate device.

According to one aspect, when the ID number of the intermediate device is transmitted to the main device, a message in this regard is sent by the intermediate device to the controlling server. Accordingly, said message may be required by the controlling server as an additional condition for the issuance of the authorization message/notification by the controlling server.

According to one aspect, when the (e.g., encrypted) security code is transmitted to the main device, a message in this regard is sent by the intermediate device to the controlling server. Accordingly, said message may be required by the controlling server as an additional condition for the issuance of the authorization message/notification by the controlling server.

Preferably, at least during a lapse of time starting at the beginning of transmission/capturing 6074 of the ID number of the intermediate device 1002 to/by the main device 1001 until the accomplishment of transmission 6077 of the security code to the main device 1001, said intermediate device 1002 and said main device 1001 are/must preferably be kept in said/an approached status (e.g., within the range of their corresponding NFC), otherwise (e.g., if the two devices are moved far from each other such that they become out of the range of their corresponding NFC), preferably, said authentication procedure is canceled (e.g. by the controlling system/server) and the security code will-not/cannot be transferred-to/captured-by the main device 1001 from the intermediate device 1002 (e.g., the intermediate device is not authorized to transmit the security code to the main device and/or the main device is not authorized to capture the security code from (e.g., an Ntag of) the intermediate device. Different methods for making sure that said devices are kept in said approached status during said lapse of time may be used by the authentication system.

Note that the procedure described above may be executed slightly differently. As an example, an/the ID number of the main device may be transmitted to the main device and the main device may send the combined information to the controlling server.

With continuous description of the current embodiment, preferably, after receiving the encrypted security code from the intermediate device 1002, the encrypted security code in decrypted in the main device 1001 and is transferred/transmitted 6078 to the account server 1009 upon which the corresponding login procedure is accomplished.

The current embodiment is especially useful if/in-case-that the intermediate device 1002 (e.g., a smartwatch) does not have an active NFC chip/mean and/but has a NFC tag (e.g., herein may be referred to as “passive Ntag”) only, within which the/a unique ID number (e.g., that may preferably be used as an (e.g., additional) ID number) for-representing/of the intermediate device is (e.g., predefinitly) registered/stored and can be read by the main device 1001 (e.g., a smartphone) which has an active NFC means. In this case, when the intermediate device receives the encrypted security code, the user is preferably required to approach the main device and the intermediate device such that the/an NFC reader of main device can read the unique ID number of the passive Ntag and transmit it to the controlling server for verification. After receiving the transmission authorization from the controlling server, the intermediate device may transmit the encrypted security code to the main device by a transmission system other than a NFC transmission system (e.g., for example by a long-range transmission system such as Bluetooth, wifi, cellular, etc.). For such purpose, for security purpose, during a very short amount of time (e.g., one second) before transmission of the security code to the main device, the intermediate device is required to be kept in the (e.g., communication range) of the NFC reader of the main device.

Preferably, the controlling application and/or the account server application running within the main device executes the decryption procedure only if the main device and the intermediate device are in the NFC communication range. For verifying such condition, as an example, the main device repeatedly with a very short interval of time (e.g., less than 100 milliseconds) attempts to read a data (e.g., the Ntag unique ID number) of the intermediate device until the decryption procedure is successfully accomplished/ended.

If the communication between the NFC reader of the main device and the Ntag of the intermediate device is interrupted before the decryption procedure is accomplished, the decryption procedure becomes/is preferably suspended/canceled.

Near Field Communication tags (e.g., NFC Ntag) are tags that are used by Near Field Communication systems and are known in the industry. A NFC tag can be, one of, a read-only tag and a read/write tag (e.g., Ntag). When a device (e.g. an intermediate 1002) has a read/write tag, the/a security code received from an account server (e.g., 1009) may be written on said tag (e.g., by a controlling application running within said (e.g., intermediate 1002) device) and be read/captured-by a/the main device (e.g., 1001) through an NFC communication system (e.g., of the main device). Same may be applied to an ID number assigned to (e.g., memorized in Ntag of) any (e.g., an intermediate) device.

Note that the NFC tag may be implemented anywhere within a wearable device. As an example, instead of being integrated with a smartwatch, the NFC tag may be implemented/attached to the wrist band of the smartwatch. Alternatively, the NFC tag may be implemented/attached to the a cloth of a user and under the skin of the user, in a pendent, etc.

Note that, throughout this patent application, a security code and/or an ID number and/or other information is mentioned as to be sent/transmitted through a/any short-range communication system by/from a first device such as an intermediate device to a second device such as a main device. It is understood that, alternatively (e.g., in some cases of a NFC communication system), said information may be captured/read/caused-to-be-transmitted by said second (e.g. main) device from said first (e.g., intermediate) device (e.g., or vice versa).

As mentioned before, based on the principles of Authentication circuit of the invention, different systems of (e.g., a user's) authentication may be created. According to one embodiment of the invention and by considering the exemplary FIGS. 6L to 6M an authentication circuit is described. In this example, at least one of the following steps may be executed for an authentication followed by execution of a function: Step 1) a user, using (e.g., an account server application 100101 running in a) main device 1001, may transmit (e.g., herein may be referred to as “send”) 1081 (e.g., by Internet) a (e.g., login) request for accessing an (e.g., his/her) (e.g. bank) account within an (e.g., a bank) account server 1009.

Step 2) A (e.g., random) security code is created by the account server. Said security code is encrypted by the account server using an encryption key (e.g., herein may also be referred to as “decryption key”). The account server 1009 may send 1082 (e.g., by SMS) the (e.g., an encrypted) security code to the intermediate device 1002. In addition, the account server 1009, immediately or sometime thereafter, may preferably also send (e.g., by SMS), to the intermediate device 1002, a link to a software/application) which (e.g., will be described/used in steps 7 and 9) so that by tapping on said link, said application is installed and run within the intermediate device 1002. Optionally, instead of a link, an account server's software/application is sent and installed (e.g., automatically) within the intermediate device.

Step 3) the account server 1009 may (e.g., simultaneously) send 1083 the/a corresponding decryption key to the main device 1001.

Step 4) the main device 1001 may send 1084 an access request/may-access to the circuit controlling server 1019 to verify if said main device 1001 is authorized to transmit the (e.g., received) decryption key to the intermediate device 1002. Alternatively/additionally, the intermediate device may send an access-request-to/may-access the circuit controlling server 1019 to verify if said/the intermediate device 1002 is authorized to retrieve (e.g., through a NFC system) the decryption key from the main device 1001. Step 5) the circuit controlling server gives/permits a/the requested access to the main device and sends 1085 the/a data/information corresponding the corresponding circuit controlling account to the main device 1001.

Step 6) After verification of the received data/information preferably by an (e.g., a controlling) application running within the main device 1001, if said application finds out/recognizes that said main device 1001 is authorized to transmit the decryption key to the intermediate device 1002, then, (e.g., during a predefined lapse of time (e.g., thereafter)) if the user approaches the intermediate device 1002 and the main device 1001 to each other such that an NFC communication becomes established between the intermediate device 1002 and the main device 1001, then the decryption key is transferred 1086 from the main device 1001 to the intermediate device 1002 through the NFC communication system. Optionally, after the intermediate device 1002 and the main device 1001 are approached to each other such that a NFC system is established, the intermediate device 1001 may retrieve the decryption key from the main device 1001 (e.g., using said/an NFC system).

Step 7) on the intermediate device 1002, the encrypted code is decrypted using the decryption key and a/the software transmitted by the account server 1009 (e.g., in step 2) to the intermediate device.

Step 8) the decrypted code 100201 is shown/displayed on the screen of intermediate device 1002 (e.g., see FIG. 6M).

Step 9) the user types the decrypted code within a corresponding (e.g., text) field 100202 of an interface of a/the software transmitted (e.g., in step 2) by the account server 1009.

Step 10) the decrypted code is sent 1087 (e.g., by said/a software, through the Internet) to the account server 1009, by the intermediate device 1002. (e.g., Optionally, the decrypted code may be transferred to the main device and from there to the account server.) Step 11) the account server 1009 compares the received decrypted security code with the security code created in step 2. If said security codes are identical, then authentication procedure is successfully accomplished and the account server gives access to the user's account (e.g., through/by-displaying a corresponding interface 100102 of the account server 1009) on the main device 1001.

Note that in the instant embodiment, the intermediate device 1002 is, preferably, a smartwatch.

With continuous description of the current embodiment, according to one aspect, both, the intermediate device and the main device, may preferably have a read/write NFC chip. Alternatively, a first device (e.g., preferably, the main device (e.g. a smartphone)) may have a NFC (e.g., read/write) chip and the/a second device (e.g., preferably, the/an intermediate device (e.g., a smartwatch)) may have a (e.g., read/write) NFC tag. In this case, according to a preferred aspect, in Step 6, as an example, the main device 1001 writes the decryption key within the NFC tag of the intermediate device 1002. In this case, preferably an/the operating system of the intermediate device may have access to the information in the Ntag.

Note that, optionally, the order in the above mentioned steps 1 to 11 may be (e.g., slightly) different. Also, the direction in at least a portion of the authentication circuit may be reversed (e.g., the intermediate device may send/transmit the (e.g., encrypted) security code to the main device and the decryption procedure may be executed within the main device preferably by a software sent to the main device by the account server. Etc.

According to one embodiment, the/an account server is part of a/the communication network of the invention. In this case, according to one method, the account server may have an API that can be used by the controlling application so that an/some information (e.g. a security code) sent by the account server to a (e.g., an intermediate) device of the authentication circuit using said controlling application, may be capture/receive by a controlling application running within said intermediate device. Said API, may also be adapted to capture/receive an information sent (e.g., by using said controlling application) from a (e.g., main) device of the authentication circuit to the account server and vise versa. Alternatively, the account server may use an API of the authentication circuit for the/said purpose.

According to one aspect, instead of each time entering an/the URL of an account server for logging in to his/her corresponding account, a user may use an application (e.g., by downloading the application from a website such as an app/play store, etc.) that permits to connect the user's device to a corresponding server upon-activating/through said application. The use of an application for simplifying the procedure of signing in to and/or logging in to an account within an account server is known in the industry and/or by people using mobile or fixed devices.

An application used for connecting and/or using a user's device to a payment terminal for the purpose of a payment for goods purchased by a user may herein be referred to as “payment application”. An example of such application is Apple Pay, Google Pay, etc.

Authentication procedure(s)/system(s) described in this patent application can (e.g., is/are designed to) be used for executing (e.g., by a user) a (e.g., any) (e.g., password protected) software and/or a (e.g., any) (e.g., physical and/or a virtual) function without using a password wherein executing said software and/or said function (e.g., by said user) requires an authentication procedure (e.g., of a/the/said user). As an example, the/an authentication system of the invention may be used for executing functions such as opening a door without using a password, making a payment without using a password, transferring money without using a password, unlocking (e.g., logging in to) a user's protected account in a (e.g., remote) server without using a password, accessing an account in a (e.g., a personal computer (e.g., in this case, the personal computer may preferably functions as an/the account server)), Permission to accessing/doing a task, confirmation of a condition, etc.

Also as an example, in the example of FIG. 6L to 6M, the account server 1009 may be a server that (e.g., automatically) executes a function such as opening a door after an authentication is accomplished. In this example, in step 1, (e.g., through an application for opening a door installed a the main device) a user may send a request for opening a door to the account server. After accomplishment of the authentication procedure, in step 11, (e.g., a software in) the account server preferably (e.g., automatically) opens the/a corresponding door. As an example, by considering the exemplary FIG. 6C, an account may be created within an/the account server 1009 (e.g., dedicated to controlling the locks (e.g., the locks having a sensor/system that can be activated remotely for opening and/closing said locks) of the doors of the rooms of a hotel) for a specific/predefined lock 1029 (e.g., of a corresponding door) of a room of a hotel. A function consisting of unlocking said (e.g., door) lock may be assigned to said account within an/the account server 1009. Some information (e.g., telephone number, a unique ID, etc.) relating to a main device 1001 and an intermediate device 1002 of a guest occupying/to-occupy said room may be provided to a said account. As an example, an app for opening said door may be installed on a guest's main device 1001. When the user open/activates said app, an/the authentication procedure of the invention may be performed for logging into a/the/said account. After successful accomplishment of the authentication procedure and accessing said account, according to a first method, the account server 1009 may automatically unlock the corresponding lock 1029 (e.g., by sending a corresponding signal to said lock).

According to a second method, said account may have different functions/options such as “unlock”, “lock”, “unlock for a predefined laps of time”, etc. In this case, the user may select a desired function/option for executing it. Note that for opening the lock 1029 of the door the account server 1009 may use a (e.g., remote) communication system 1028 such as Wifi, cellular, Bluetooth, etc.

Preferably, for each different lock (e.g., of a different door) of the hotel a different account may preferably be created within the account server 1009. It must be noted that, preferably, for the functions that are not critical/important, some steps such as steps 8 and 9 may not be necessary. In this case, after the step 7, the controlling server's software (e.g., running within the intermediate device 1002), may automatically send the decrypted security code to the account server 1009.

Note that examples of Step 1 to 11 are provided to describe the gist of the invention. Other procedures of authentication based on principles described herein may be considered. As an example, after in Step 2, the (e.g., encrypted) security code may be sent to the main device, and in Step 3, the decryption code may be sent to the intermediate device. Also as an example, the decryption key may be transmitted to the main device by/from the intermediate device and the decryption procedure may be executed on the main device. Etc. According to a preferred aspect, the authentication system of the invention may be described in a simplified manner as follows:

Authentication system of the invention comprises of an authentication circuit using a first (e.g., a main) device, at least a second (e.g., intermediate) device and a controlling (e.g., remote/cloud) server. The authentication circuits may preferably work independently from a specific account server, but in-cooperation-with/used-by each of a plurality of account servers for executing a function related to a user's account within an account server. To execute a desired function related to a user's account:

a) The user sends an access/login request for executing a function to a corresponding account server.

b) The account server creates a random security code, encrypts the security code using an encryption key and sends the (e.g., an) encrypted (e.g., random/arbitrary) (e.g., one-time) security code to the intermediate device.

c) Additionally, the account server sends a corresponding decryption key to the main device.

d) The intermediate device contacts/accesses the controlling server to find out if said intermediate device has an authorization for transferring the (e.g., encrypted) security code to the main device.

e) (e.g., only) upon having said authorization, the security code is transmitted from the intermediate device to the main device. Transmission procedure of the (e.g., encrypted) security code from the intermediate device to the main device is preferably executed by a near field communication (NFC) system having preferably at most a range of few centimeters (e.g., less than 10, or less than 5, or even less than 3 centimeters) (e.g., herein may be referred to as “NFC range”).

f) Upon receiving the (e.g., encrypted) security code on the main device, said (e.g., encrypted) security code is decrypted by a software (e.g., of the account server) using the decrypting key.

g) The decrypted security code is sent either automatically or manually to the account server.

h) After matching the received decrypted security code to the security code created in step (b), the account server executes a/the corresponding function.

Preferably, the main device is a non-wearable device (e.g., a smartphone). Preferably, the intermediate device is a wearable device (e.g., a smartwatch).

In the latter example of steps (a) to (h), the order and/or the aspect of some of the items/steps may be reversed/changed. As an example, the (e.g., the encrypted security code may be sent to the main device and the decryption key may be sent to the intermediate device.

The authentication system may be described in a still simpler manner as follows:

Authentication system of the invention may be comprised-of/include an authentication circuit using a first device, at least a second device and a controlling (e.g., remote/cloud) server. To execute a desired function related-to/by a user's account within an account server, an authentication procedure is performed as follows:

a) The user (e.g., through first device) sends an access request for executing a function to a corresponding account server.

b) The account server, using a software, creates a (e.g., one-time) random security code and preferably encrypts said security code using an encryption key.

c) The account server sends a (e.g., an/the encrypted) (e.g., random/arbitrary) (e.g., one-time) security code to the second device.

d) The account server sends the decryption/encryption key to the first device.

e) The second device contacts the controlling server to find out if said second device has an authorization to send said encrypted security code to the first device.

f) If having such authorization is confirmed/obtained, the second device transmits the (e.g., encrypted) security code to the first device.

g) The security code is decrypted (e.g. within the first device) by a corresponding software using the decryption key.

h) The decrypted security code is transmitted to the account server.

i) The account server compares the received decrypted security code with said random security code created in step 2.

j) Upon matching said (e.g., security) codes, the system executes said function.

In the above, optionally, the order may be changed (e.g., the (e.g., encrypted) security code may be sent to the first device and the decryption key may be sent to the second device).

Online payment companies are in charge of handling online or internet-based systems/methods/services/processes of payment/money transactions. Online payment systems and/or services may be defined in different categories, such as: Category a) online payment systems which allow the/a seller (e.g., a merchant) to accept payments and the/a buyer (e.g., a cardholder) to make payments over the internet. Examples of online payment companies include PayPal, Google Pay.

Category b) payment services/services of companies handling payment through credit card/debit card such as Visa, MasterCard, Diners, etc., may also be available when purchasing goods on the Internet and/or in a physical store. In the latter, Category c) there may be other companies providing services for transacting payments from one entity to another entity.

A credit card transaction process is generally complex and has a number of participants in a credit card transaction. Each transaction passes through multiple phases involving several different parties before the seller gets the funds. As an example, a payment terminal and/or a software of the store or of an eCommerce/online shop with whom a cardholder has initiate a purchase, sends the credit card information of the cardholder to the merchant's bank (e.g., herein may be referred to as “acquiring bank”. Acquiring bank, then, sends a request for payment authorization to the bank issuing the credit card. A request for payment authorization of a credit card transaction goes through a number of participants and networks (e.g., herein may be referred to as “channels”) until it is received by the bank issuing the credit card. An approval or decline response from the bank, said response is sent back along the same channels to the acquiring bank.

When a buyer/user proceeds to a procedure for providing a payment for a goods, a service, transfer of funds, etc., through any of above mentioned (e.g., or other) payment categories, at some instance during the corresponding transaction process said buyer/user may be required to proceed through an authentication procedure for preventing fraud. Said authentication procedure may require some information to be provided by the user. Said information may be providing a password, a (e.g., one time) security code sent to the user's smartphone during the authentication procedure, a username, etc.

Generally, said information is required by a/the company/institution (e.g., the user's bank, PayPal, etc.) paying the amount of the transaction on behalf/for the user/buyer. For facilitating the simplifying the specifications of this patent application said institutions is herein referred as “payment server”.

According to a preferred embodiment, when a user selects an (e.g., one or more) item (e.g., herein may be referred to as “goods”) in an online shopping store (e.g., herein may be referred to as “online store”) and proceeds to the payment of the (e.g., purchase amount of) selected goods (e.g., by selecting the/a payment method through a credit card), the online store may preferably redirect the user's device to a payment server which handles payments through the (e.g., the selected) credit cards. Thereafter, the/a webpage (e.g., of the payment server) displayed (e.g., on the screen of the main device after redirection) may require/consider the credit card number of the user as the identification information/number of the user.

After providing the credit card number by the user, the payment server identifies the corresponding user account within a database of accounts within/used-by the payment server (e.g., or within a corresponding bank/financial-company). Based on the login information (e.g., such as user's main device telephone number, user's intermediate device telephone number, etc., previously (e.g., during the creation/registration of the account) stored within/related-to the user's account), the payment server proceeds to an authentication system/procedure of the invention (e.g., by sending a (e.g., an encrypted) security code to an/the intermediate device of the user and a corresponding encryption/decryption key to the main device of the user. And so on (e.g., the rest of the authentication procedure of the invention, as described throughout this patent application, is executed). After successful accomplishment of the authentication procedure, the payment server credits/causes-to-credit (e.g., a bank account of) the online store for the amount of purchased goods and debits/causes-to-debit (e.g., a bank account of) the user for the amount of purchased goods. The current embodiment practically eliminates the risk of fraud using credit cards as a means of payment (e.g., specially, in online stores) and as a means of (e.g., online) transfer of funds from one account to another account, etc. This is because even if a user provides his/her credit card number to a merchant, the merchant cannot make a use of it because the use of the card requires an authentication system (e.g., of the invention). Note that in the current embodiment, the username (e.g., the credit card number) may be provided through/by one of, a Ntag, typing, copy-and-paste, introducing the card within/to a corresponding machine, etc.

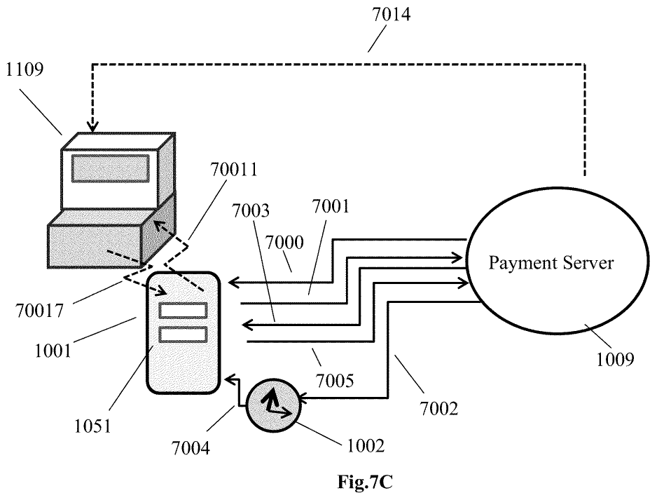

As mentioned, authentication system/procedure of the invention may be used/combined/integrated with an online payment system to provide a highly secure (online) money-transaction/payment. As an another example and not by way of limitation, FIGS. 7A to 7C and the corresponding explanations below are used to describe other exemplary methods of integration/use-of the authentication system/procedure of the invention within/with the (e.g., above-mentioned) payment methods/systems.

Exemplary FIG. 7A, is used to describe a system of secure online payment using an authentication procedure/circuit of the invention. In this example the account server 1009 is an online server of a financial/payment company (e.g., the user's bank, a credit card company (e.g., such as Visa or Master Card, Paypal, a server which provides online (e.g., transactions) services to one or more credit card companies, etc.) with/in which a user has an account. Such server may herein be referred to as “payment server”.

In order, for the user, to use the payment service of a payment company, the payment company must have certain information related to the user. Some of said information (e.g., user's credit card information) may be provided during opening an account in a financial/payment company (e.g., a bank) and/or a (e.g., corresponding) payment company (e.g., PayPal).

Preferably, the payment server/financial company/institution (herein may be referred to as a “bank) has the contact information (e.g., email address, telephone number, etc.) of the user. As an example, a bank in which a user has an account may provide a credit/debit card (e.g., for purpose of simplicity, herein may be referred to as “credit card”) to a user. Preferably, said bank has user's contact information such as user's name, user's email address, user's telephone number (e.g., of a main device and/or a an intermediate device), user's address, etc. Such information is usually provided by the user to the bank when the user opens an account within the bank. Preferably, the provided credit/debit card has at least one of, an (e.g., identification) number, an expiration date, a security number (e.g., generally, printed in the back of the card), the owner's name, etc. At least some (e.g., preferably, all) of those information are linked to each other and/or to the user's bank account. In addition, a user may also create an account in an account server of the bank, during which, the user may provide at least one of a user's ID (e.g., a “username”), a password, and preferably at least one telephone number (e.g., as described).

Also, when a user opens an account within a payment company server (e.g., PayPal), the user at least provides some information such as the name of the user, his/her address, a/the credit card information of the user (e.g., number, expiry date, security number, etc.), an email address of the user, at least one telephone number of the user, a password, etc.

With continuous description of the current invention, as an example, a user desiring to purchase goods from an online store 1109, may first enter into the website of the/an online store using a user's (e.g., main) device 1001 through a corresponding connection 70011. After selecting an (e.g., at least one) item (e.g. goods) presented/proposed on the online store webpage, the user may proceed to purchasing the item.

According to one method, if this is the first time that user desires to purchase from said online store, the online store software and/or a corresponding/related software may ask for/require certain information such as user's name, address, email, telephone number, credit card information (e.g., credit card company name, owner name on the credit card, credit card number, expiration date, security number, etc.), etc.

After selecting, by the user, a desired payment method (e.g., credit/debit card, PayPal, Visa, etc.), preferably among a plurality of choices proposed by/on the online store, depending on the selected payment method, the online store, through some channels, may send 7012 some information such as at least one of, the amount of purchase (e.g., purchase amount), the online store identification information, (and optionally, also a/the contact information (e.g., the email address, the credit card information of the user, etc.) of the user), etc. (e.g., herein may be referred to as “payment information”) to the selected/corresponding online payment company/server. Preferably, the user and/or a corresponding financial company (e.g., user's bank) has already/previously created an account within the selected online payment server/company and all of the information (e.g., previously provided, during a corresponding sign-in procedure, to a corresponding payment company (e.g., bank, PayPal, etc.) required by the/a corresponding authentication circuit is already stored in the online store database. Thereafter, different payment processing scenarios may be executed such as the exemplary scenarios described below:

Scenario (a)—According to a first aspect/option, the selected payment company is an online payment company of category (a) (e.g., PayPal, a server of a company that handles the payment transaction for a number of credit card companies (e.g., herein may be referred to as “transaction server/payment server”)). In this case, the online store server may preferably redirect 7012 the user (e.g., the user's device connection) to a/the corresponding (e.g., webpage of the) selected payment server (e.g., in this example, server 1009) (e.g., PayPal, transaction server, etc.). Then, the payment server, may proceed to authentication procedure of the invention using/through an authentication circuit, as described throughout this patent application. In this example, the (e.g., communication) procedure of the exemplary authentication circuit is demonstrated by continued lines/arrows (e.g., 7000-7005) and the authentication circuit devices include exemplary main device 1001 (e.g. a smartphone, a PC, etc.), the exemplary intermediate device (e.g., a smartwatch) 1002, (preferably, a authentication circuit controlling server (e.g., not shown) and the exemplary payment server 1009. As such, as an example and not by way of limitation, after receiving the/a some information such as the purchase amount of selected/to-be-purchased goods, identification information (e.g., email address, username) of the user, identification information of the online store, etc., provided by the online store server and/or by the user to the payment store and matching it to a corresponding entry of the database of the payment server, the payment server may proceed to an authentication procedure (e.g., of the invention). (Note that, alternatively, after redirecting the (e.g., the corresponding device of a/the) user to a corresponding online payment server, the user himself/herself may enter/provide some information such as his/her identification information (e.g., the username (e.g., credit/debit card number), email address, etc., (e.g., that he/she and/or the/a corresponding bank/financial company has been previously provided at least some of said information to the online payment store during a sign-in procedure and/or during the creation of the account)) to the (e.g., log in webpage of the) payment server and/or a related entity (e.g., a corresponding bank). In the current example, when/after the online store redirects the user (e.g., user's device) to the payment server, the user may be required to enter at least one user's identification information for the/an (e.g., a desired) account within the payment server (e.g., such as username (e.g., user's credit/debit card number, user's username if a transaction server is selected, or user's email address (e.g., as the user's username) if PayPal is selected, etc.)).

Thereafter, based on the provided identification information, the payment server may proceed to the authentication procedure of the invention (e.g., by sending an encrypted security code to the user's intermediate device (e.g., a smartwatch 1002) and the decryption/encryption key to the user's main device (e.g., a smartphone 1001) and so on (e.g., the rest of the authentication procedure/circuit of the invention is executed). After successful accomplishment of the authentication procedure, the payment company debits a/the corresponding user's (e.g., bank) account and credits a corresponding online store's (e.g., bank) account for the amount of goods being purchased (e.g. and preferably informs 7013 the online store).

In the current embodiment, optionally, identification information of the user may not be transmitted to the payment server. In this case, after selecting, by a user, a payment method (e.g., PayPal, credit/debit card (e.g., visa, Mastercard), etc.) in a corresponding interface/webpage of the online store, the online store my redirect (e.g., 7012+7000) the (e.g., browser of the) user's device to a website/webpage of (e.g., the/a company corresponding to) the selected payment method, the user may be required, by the webpage (e.g., of the payment company) to enter/send/provide 7001 an (e.g., his/her) identification information (e.g., such as at least one of, username, credit card number, email address, etc.) required for logging-into/using his/her account (e.g., for the payment of the amount of the goods selected, by the user, on the online store) within/through said payment server. Based on the provided identification information, the payment server may preferably proceed to the authentication procedure of the invention. As an example, the payment server 1009 may send 7002 a security code to the intermediate device 1002 and may also send 7003 a/the corresponding decryption key to the main device 1001. After accessing, by the intermediate device, to the/a corresponding controlling server (e.g., 1019 as described in FIG. 6A) for a permission status procedure, if the (e.g., corresponding controlling application running within the) intermediate device 1002 recognizes that the intermediate device 1002 is authorized to transfer the encrypted security code to the main device 1001, the encrypted security code is preferably transmitted 7004 to the main device 1001. Thereafter, the encrypted security code is decrypted in the main device 1001 and the decrypted code is sent 7005 to the payment server 1009.

With continuous description of the current embodiment, after matching (e.g., by/in payment server 1009) the received decrypted security code with the original security code, the authentication procedure is successfully accomplished. Thereafter, the payment server 1009 may preferably authorize the payment and may credit the (e.g., (e.g. the bank account of the) online store 1109 for the amount of the payment (e.g., accordingly, the payment server may inform 7013 the online store 1109 in this regard). Accordingly, the payment server 1009 may debit the corresponding (e.g. bank) account of the of the user. Note that after the payment procedure is processed, the (e.g., the browser of the device 1001 of the) user may be redirected (e.g., by the payment server) back to the online store website 1109.

Note that earlier (e.g., during creation/registration of an account within a payment server), the contact information (e.g., a telephone number) of the/a intermediate device of the user and preferably the contact information (e.g., a telephone number) of the/a main device of the user is/are preferably registered within the corresponding account of the user within the payment server.

Note that, an identification information of a user may herein be referred to as “username”.

As such, (e.g., after redirecting the user's device, b an online store) to a webpage of the/a selected payment server) at least some of the following steps will preferably be provided/executed:

1. Optionally, the payment server may send 7000 a request (e.g., in a webpage) for payment including, for example, (e.g., at least) the name/identification-information of the online store and the amount of purchase to the user's main device 1001.

2. Optionally, the user (e.g., through the user's main device) may preferably send 7001 a confirmation message to the online server (e.g., by providing a predefined action such as providing his/her username and pressing a virtual (e.g., send) key/button on the received webpage).

3. (e.g., Based on the received username,) payment server may preferably send 7002 a (e.g., an encrypted) security code, preferably by SMS, to the intermediate (e.g., smartwatch) device 1002 of the user (e.g., which preferably has a STM card and used cellular communication ability).

4. Optionally/preferably, the payment server may send 7003 a corresponding decrypting key/code, preferably through Internet (e.g., optionally by SMS), to the main (e.g., smartphone, PC, tablet, etc.) device 1001 of the user.

5. Preferably, (e.g., after contacting the controlling server 1019 and getting/acquiring authorization), the intermediate device 1002, preferably using a short-range (e.g., an NFC) communication system, redirects/send 7004 the (e.g., encrypted) security code to the main device 1001.

6. The main device 1001 (e.g., after decrypting the encrypted security code) may preferably send 7005 the decrypted security code to the payment server 1009, for completing the authentication procedure.

According to one aspect, the decrypted security code is sent automatically to the payment server.

According to another aspect, the decrypted security code is entered/typed manually by a/the user and sent to the payment server.

7. Preferably, after verifying and matching the received security code to the sent original security code, based on the information received from the online store 1109, the payment server 1009 (e.g., through a/the corresponding financial institute) (e.g., remotely 7013), through some channels, credits (e.g., send the payment to) a corresponding (e.g. bank) account of the online store 1109 and debits a corresponding (e.g. bank) account of the user.

Scenario (b)—According to a second aspect/option, the selected payment company is an online payment company of exemplary category (b) (e.g., a user's bank). In this case, the online store server may preferably request the user's payment information before redirecting the user, through some channels, to the user's/a corresponding online payment server (e.g. the user's bank server). As an example, if the user chooses to pay the purchase amount of the selected item/goods by a credit card, the user may fill a (e.g., standard) webpage, corresponding to an online payment through credit/debit card, presented on the online store webpage. After filling the required user's credit card and other information, said information is preferably sent, through some channels, by the online store to a/the corresponding online payment server 1009 of the corresponding credit card and preferably, the user (e.g., user's device connection) is redirected to the corresponding online payment server 1009. Then, an authentication procedure including (e.g., at least some, preferably, all of) the steps (1) to (7) of scenario (a) may be executed. After the authentication procedure is successfully accomplished, the payment server may preferably authorize the payment and may preferably credit the an (e.g. the bank) account of the online store accordingly (e.g., for the amount of the purchased goods), and debits the corresponding (e.g., bank) account of the owner of the credit card accordingly. Accordingly, preferably, the payment server may inform 7012 the online store in this regard.

It must be noted that examples of scenario (a) and (b) are shown exemplary scenarios are described to explain the principles of transfer of funds securely, without the need of a password, by using the authentication system of the invention. Those principles may be applied to any other examples of transferring funds securely, based on in accordance with said principles.

In the examples above, a payment server is described to be the institute/entity (e.g., a bank, PayPal) transferring funds to a supplier on behalf of a user. It is understood that said institute/entity may be of any kind, and user and said supplier may be any type of physical and/or virtual entity.

FIG. 7B shows, as an example, a method/system of payment for goods/items purchased in a physical store (e.g., a supermarket, shoe store, etc.) using the authentication procedure of the invention (e.g., without providing/using a password). As shown in FIG. 7B, the procedure of the payment may, preferably, be similar to that of FIG. 7A, with the difference that, here, the online store webpage/website is replaced by a physical store's point of sale machine/terminal “POS” 1109 (e.g., herein may be referred to as “cashier terminal”).

In the current example, after the value of goods (e.g., to be) purchased by a user/buyer is calculated (e.g., by the/a cashier terminal, or manually, etc.), the user/buyer may preferably connect 70011 his/her main device 1001 to the cashier terminal 1109 (e.g., or vise versa), preferably, through a near field communication system “NFC” (e.g., or through another short-range communication system). For such purpose, the user may position his/her main device 1001 adjacent/closed to the cashier terminal 1109.

After the cashier terminal and user's main device can/do communicate with each other (e.g., automatically, or optionally, upon providing a predefined interaction such as pressing a key on the user's and/or the cashier device) the user's main device 1001 may send, (e.g., through a payment application installed in the user's main device 1001), some information such as the credit card information (e.g., card number, expiry date, the 4-digit security code, etc.) of the user to the point of sale/cashier machine/terminal. Thereafter, the cashier terminal 1109 may transmit 7013, through some channel, the/said information and preferably some additional information such as the amount of the purchase and the information corresponding to the physical store to a corresponding payment server 1009 (e.g., the user's bank server). At this time, the payment server may proceed to an authentication procedure of the invention as described throughout this patent application in general and similar to the authentication procedure (e.g., at least some (e.g., steps (3) to (7)), preferably, all of) the steps (1) to (7) of scenario (a)) explained in regard to purchasing goods in online store as described above. During the authentication procedure, preferably the amount to be debited is shown on the user's (e.g., main) device by the payment server. In this example, the communication procedure of the exemplary authentication circuit is demonstrated by continued lines/arrows (e.g., 7000-7005) and the authentication circuit devices include exemplary main device 1001 (e.g. a smartphone, a PC, etc.), the exemplary intermediate device (e.g., a smartwatch) 1002 and the exemplary payment server 1009. After the authentication procedure is successfully accomplished, the payment server may preferably authorize the payment, and may credit the (e.g., (e.g. the bank account of the) owner of the account related to the) cashier terminal for the amount of the payment/purchased goods, and debits the corresponding account of the owner of the credit card. Accordingly, preferably, the payment server may inform 7012 the cashier terminal in this regard.

As mentioned before, the authentication procedure/system of the invention can/may be integrated within/used-with any payment system. FIG. 7C shows, as an example, a payment system (e.g., for paying for goods to be purchased in a physical store) similar to that of FIG. 7B with the difference that, here, after calculating the amount of purchase of the user, the physical's store cashier/payment terminal (herein may be referred to as “cashier/payment terminal”) may preferably provide/send 70017 (e.g., preferably through an NFC communication system, some (e.g., necessary) information such as the amount of purchase of the user and the physical store's (e.g., bank) account information (e.g., transfer information) to the main device 1001 of the user. Then the user's main device may preferably send said information to a payment server (e.g., in which user has an account) by the/a corresponding payment application (e.g., installed and) used by/in the user's device 1001. At this time, the user's payment server may proceed to an authentication procedure similar to that of steps (2) to (7) in relation o (e.g., as described in) FIG. 7A. In this example, the communication procedure of the exemplary authentication circuit is demonstrated by continued lines/arrows (e.g., 7000-7005) and the authentication circuit devices include exemplary main device 1001 (e.g. a smartphone, a PC, etc.), the exemplary intermediate device (e.g., a smartwatch) 1002 and the exemplary payment server 1009. After the authentication procedure is successfully accomplished, the payment server may preferably authorize the payment, and may credit the (e.g., (e.g. the bank account of the) owner of the account related to the) cashier terminal for the amount of the payment/purchased goods, and debits the corresponding account of the owner of the credit card. Accordingly, preferably, the payment server may inform 7014 the cashier terminal in this regard.

Note that in the exemplary embodiments of FIGS. 7A to 7C, the user owns/controls the main device 1001 and the intermediate device 1002. In a (e.g., ideal) mobile environment, preferably, the main device is a smartphone (e.g., optionally a tablet, a smartwatch, a laptop, etc.) and the intermediate device is preferably wearable device such as a smartwatch (e.g., worn on a wrist of the user). Preferably, both, the main device and the intermediate device each have a SIM card (e.g., both have cellular communication ability) with preferably different (e.g. telephone) numbers and NFC communication systems/ability. Optionally, at least the intermediate device has/uses a SIM card (e.g., such device may be a smartwatch which herein may be referred to as a “standalone smartwatch”). Preferably, a (e.g., the encrypted) security code sent by a payment server to the intermediate device is sent through SMS using the intermediate device's (telephone) number.

Preferably, (e.g., at least in case of embodiment/example of FIG. 7B), the/a decrypting key/code is sent (e.g., by the payment server) to the main device 1001 by SMS. In this case, preferably, the payment server may have, both, the telephone number of main device and the telephone number of the intermediate device (e.g., said telephone numbers are preferably provided in advance (e.g., when opening an account) to a corresponding user's financial organization (e.g., user's bank, a corresponding payment server, etc.)).

Optionally, the user's bank may provide said information (e.g., in advance or upon a corresponding payment interaction by user with the payment server) to the payment server.

With continuous description of said (e.g., 7A to 7C) embodiments, preferably, an NFC communication system is used between the intermediate device and the main device for forwarding/sending an/the (encrypted) security code from the intermediate device and the main device.

Preferably, an NFC communication system/protocol is used between the main device and the payment/cashier terminal for transmitting (e.g., in both directions) payment information (e.g., as described throughout the specification related to FIGS. 7B and 7C).

According to a first preferred concept/example, a/the user wearing an/the intermediate device (e.g., a smartwatch) on the wrist of a first hand, may preferably hold the main device in the same hand, for making a payment to an online store. This is because, in this case, intermediate device is very closed to the main device and (e.g., after getting authorization from the control server), the intermediate device can (e.g., more) certainly transmit said security code to the main device.

According to a second preferred concept/example, the user wearing the intermediate device (e.g., a smartwatch) on the wrist of a first hand, may preferably hold the main device in the same hand and approach the main device to a/the corresponding payment terminal, for making a payment to a physical store's payment terminal. This is because, in this case, the pair of devices, the/said payment terminal and the main device, are very closed to each other, and the pair of devices, the main device and the intermediate device, are also closed to each, therefore, each of said pair of devices can communicate with each other through their corresponding NFC communication systems.

Preferably, when an encrypted security code is decrypted (e.g., and shown) on the main device, a manual interaction with said main device (e.g., entering said decrypted code manually in a field of an interface displayed on the screen of the main device and/or pressing a send key, etc.) may transmit said/the decrypted security code to the corresponding (e.g., payment) server. Optionally, (e.g., after being decrypted in the main device) said/the decrypted security code may automatically be sent to the corresponding (e.g., payment) server by the main device.

It must be noted that although in the examples of FIGS. 7A to 7C, a payment server is given/brought as example of an account server of the invention participating in an authentication procedure of the invention, said server may be of another kind such as a server adapted to participate in said authentication of the invention on behalf of and/or in relation to the/a payment server.

In each of the exemplary FIGS. 7A to 7C, an entire exemplary payment procedure is shown by continued and discontinued communication arrows and a number of the devices and/or servers. Such procedure may herein be referred to as “Payment Circuit”. In FIGS. 7A to 7C, each payment circuit includes an exemplary authentication circuit of the invention. (e.g., Note that communication directions of the authentication system/circuit are shown by continuous arrows, and communication directions between a device (e.g., 1001, 1002, 1009) of the authentication system/circuit and a payment server/point of sale machine/terminal are shown by discontinuous arrows.) It must be noted that other payment circuits including a (e.g., a same or a different) authentication circuit/system of the invention may be considered by people skilled in the art based on the principles described in this patent application. As an example, a payment circuit may include/use multiple (e.g., account) servers using different communication directions and/or methods. Also, an authentication circuit of the invention may include/use multiple devices/servers using different communication directions and/or methods of communication.

An intermediate device may not be a standalone smartwatch (e.g., may not have a cellular communication capability) but rather being a connected smartwatch (e.g., using the cellular communication system of a smartphone to which it is connected for communicating with other devices). In this case, according to one embodiment, said smartphone and said smartwatch may be used, respectively, as the main device and the intermediate device of an authentication system/circuit. In this case, as an example, the/an account server may send the/an encrypted security code to said smartphone which then will transmit said security code to said smartwatch. As an example, after receiving the security code from the/an account server, the main device (i.e., the smartphone) may send the security code to the intermediate device (i.e., the connected smartwatch) by any communication means and the intermediate device preferably uses its/a NFC communication system for transmitting back said security code to said main device (i.e., said smartphone). Preferably, (e.g., only) thereafter, the decryption key is sent by the account server to the smartphone.

According to a preferred embodiment, during/for (e.g., a sign-in procedure for) creating an account within an account server, the/an identification information (e.g., a username (e.g., an email address, a unique code, etc.)) (e.g., herein may be referred to as “username”) of/related-to a user (e.g., an owner) of the account within an account server may be required by the account server. Said/the identification information/username may (e.g., thereafter) be (e.g. a) stored (e.g., data) within a (e.g., memory) medium/component such as a (e.g., passive) NFC tag (Ntag)/chip, etc. Accordingly, during a login procedure within the created account, said identification information/username may be entered/provided, by the user, through said medium/component in which said identification information/username is memorized/stored.

A Ntag used for entering an identification information of a user may herein be referred to as “ID-tag” and said identification information may herein be referred to as “username”.

According to one aspect, an ID-tag may preferably be integrated within/attached to a (e.g. credit size) card. According to a one scenario, said card may be a credit/debit card of a user, said ID-tag may be a corresponding chip/Ntag integrated within said card wherein said chip includes the credit card number, and wherein said username may be the credit card number of said credit card.

According to one aspect, said username may be stored within said ID-tag by a corresponding account server (e.g., during a sign-in procedure in which a user enters a username within a corresponding text field) or by a user using an appropriate means (e.g., a NFC writer (e.g., integrated within the user's device).

Note that a sign-in procedure is used for creating an account within an account server.

With continuous description of the current embodiment, when a user desires to make an action (e.g., such as to login within an account of said user within an account server) which requires an authentication procedure of the invention, the user may be required to provide a (e.g., corresponding predefined) username. In this case, the user may use his/her ID-tag for entering/providing the/said username.

In an account server, each user account has/is-assigned a unique username. According to one aspect of the invention, a username of a user's account may be stored within a memory component such as a Ntag that can be read by a reader device/component such as a NFC reader chip integrated within a (e.g. main) device. Said username may be stored within the memory component (e.g. Ntag) by a user himself/herself using a writing device/component, or it may be a pre-stored (e.g., identification) information (e.g., data, code, etc.) when a user purchases/obtains a/said memory component. In some cases, such is if the user's account is an account within a bank accounts server, the user's username may be defined by the bank and be stored within a memory component (e.g., Ntag) and be delivered to the user. Note than the Ntag can be delivered to the user as is (e.g., not attached to/integrated within an object/card) and the user can attach it to any object (e.g., to a pendent, to a belt, etc.). Such a memory component (e.g., Ntag) may be used with the authentication system of the invention for an extremely secure authentication procedure. For better security, said username is preferably a complex/sophisticated username comprising large number of (e.g., at least eight) characters that may preferably include at least one lowercase letter, at least one uppercase letter, at least one digit and at least one special characters, etc.

A (e.g., passive) NFC tag (e.g., Ntag/chip) may-have/has any shape (e.g. round, square, rectangular, etc.) and/or any size (e.g. if round less than 20 millimeters diameter, if square leass than 10×10 millimeter, etc.). A (e.g., passive) NFC tag/chip can easily be attached to/integrated-within an object (e.g., credit card size card, a user's bracelet/strap/pendent/belt, etc.) and/or a user's-body part (e.g. stick to user's hand, implemented under the/a skin), etc.

According to one embodiment of the invention, for better security, the login webpage of an account server of a user may require that the username to be provided through/by an Ntag that includes a corresponding username.

A login (e.g., web) page (e.g., herein may be referred to as “login webpage”) of an account within an account server, generally, may require a username and a password. According to one embodiment of the invention, when a webpage is opened on a user's device, the username may be provided through a corresponding user's memory component (e.g., Ntag) within which said username is stored. In a preferred embodiment of the invention said memory component is an Ntag and said user's device (e.g., smartphone) may preferably have a NFC reader component/chip that can read said username by approaching the user's device to the Ntag (e.g., and/or vise versa) such that a short range communication (e.g., NFC process) may be established between the user's device and the Ntag.

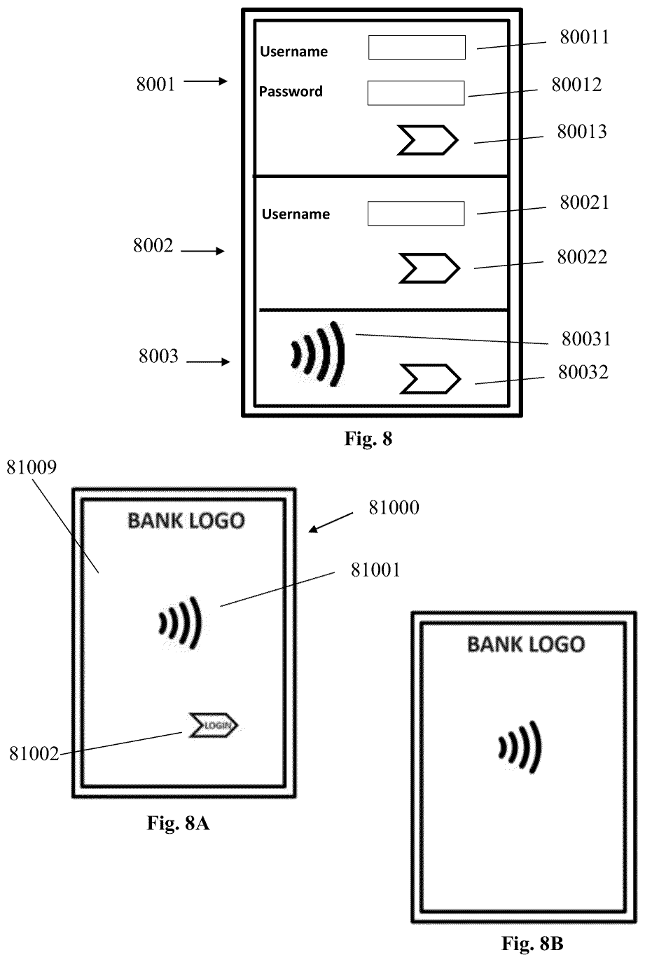

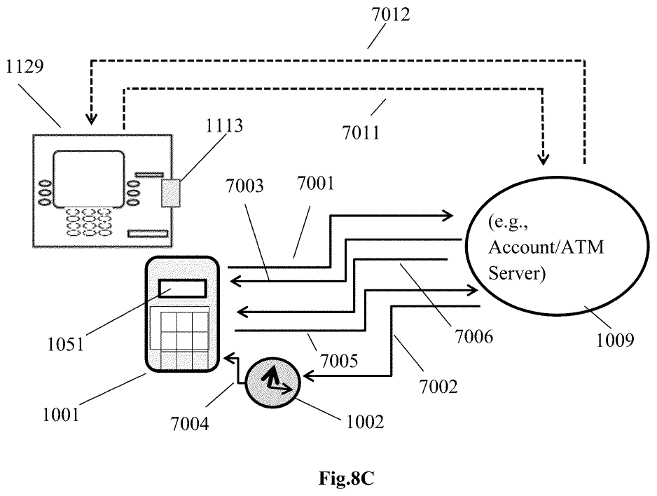

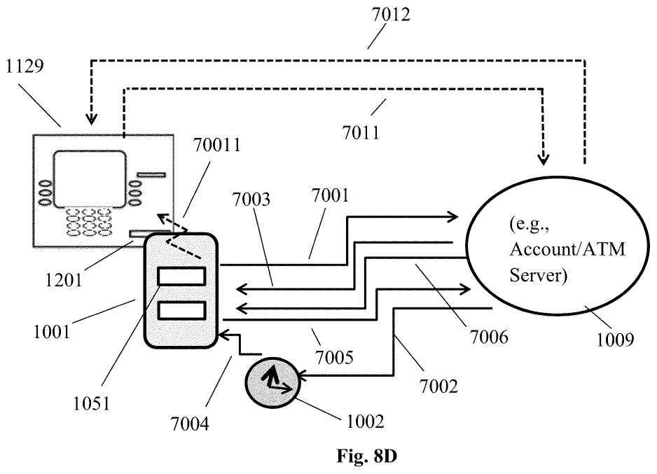

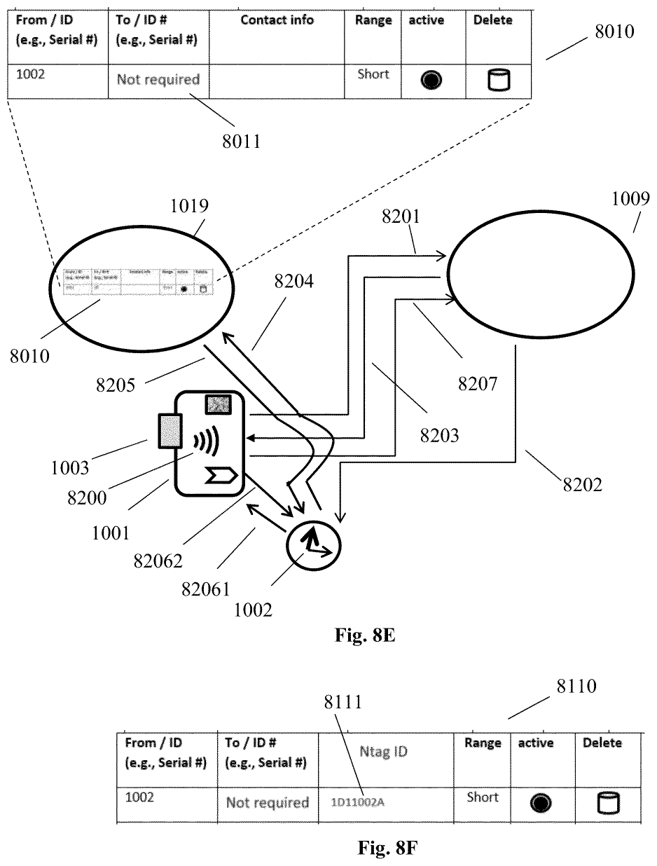

FIG. 8, shows as an example, a (e.g. login) webpage of an account within an account server (e.g., displayed on a smartwatch screen), being displayed on the screen of a user's device. This interface proposes three different ways for providing the information required by the account server to access an account. The user may proceed to a login procedure by-selecting/through one of the exemplary following sections:
In section 8001, a traditional interface for logging into an account is proposed which contains a first text field 80011 for entering a username and a second field 80012 for entering a password. After filling (e.g., by typing and/or copying-and-pasting) the corresponding/required information in both text fields, the user may press the/a Send key 80013 for sending the required login information to the corresponding account server. Thereafter, a traditional login procedure/process is executed (e.g., by the corresponding account server). No use of authentication (e.g., circuit) system of the invention is/may-be required in this case.

In section 8002, only a text field 80021 for entry of the username is proposed/displayed. In this case, a user may fill the username in the text field. Preferably, after pressing the send button 80022, the system may send the username to the account server and thereafter a corresponding authentication system of the invention may be processed (e.g., the account server may proceed to the authentication system of the invention).
In section 8003, no text field is proposed. For using this section, the user's device may preferably have a NFC reader component. In this section, a NFC icon is displayed on the screen to notify the user that he/she is required to provide the username by using a NFC system. After, approaching the (e.g., NFC reader component of the main device) to a corresponding ID-tag (e.g., the/a Ntag in which the/a username is stored) of the user the NFC reader reads the username stored in the ID-tag. Thereafter, according to a first aspect, the main device sends, automatically, the corresponding username to the account server, while according to a second aspect, the system sends the username to the account server after the user presses/taps-on the send key 80032. Thereafter a corresponding authentication system of the invention may be processed (e.g., the account server may proceed to the authentication system of the invention).

According a preferred embodiment of the invention, when a user signs into an account server for creating an account within an account server (e.g., by providing a desired username (e.g., and a password)).

Preferably, during said sign-in procedure, the user may be enabled to opt for/choose a method (e.g., among a number of login method choices) of login in which the/said username may be provided to the/said account server only through a corresponding ID-tag having the/said/corresponding memorized username. This means that, after the sign-in procedure is accomplished, during a login procedure is the created account, the login page/interface of the account server regarding to the created account, preferably, will propose an interface for entering a username, only through a Ntag (e.g., no fields for the entry of the username and the password will be proposed). Using this method with the authentication system of the invention will/may extremely augment the security/exactitude of the authentication procedure. FIG. 8A, shows and exemplary login interface 81009 of the invention according to the current embodiment in which entering a username can be provided through a Ntag (e.g., integrated in attached to a credit card type card) only. In this example, the login request can be provided only by scanning the username from a corresponding Ntag using/through a (e.g., NFC) reader (e.g., represented by the NFC icon 81001) of the device 81000. In this embodiment, after a/the username is sent to an/the account server, the account server may proceed to the authentication system of the invention. As an example, by considering FIG. 6A, a user may access to a login webpage of an account server 1009 (e.g., by tapping on an corresponding app icon on the main device 1001. If a login interface displayed on the screen is similar to that of FIG. 8A, then, the user may approach a Ntag in which a username corresponding to a user account within said account server is stored, to a/the NFC reader integrated within the main device 1001 such that that the NFC reader can read/scan said username. After reading/scanning the username, the main device 1001 (e.g., preferably, automatically) sends the username to the account server. Alternatively, the user may provide a predefined interaction with an interface of the corresponding device (e.g., such as pressing a login button 81002 displayed on the screen 81009). After receiving the username from the main device 1001 and matching it with the user's account, the account server may proceed to the corresponding authentication (e.g., circuit) procedure of the invention (e.g., as described before in regards to FIG. 6A).

According to a preferred embodiment, as shown in FIG. 8B, a/the login interface/webpage 81005 of the account server 1009 presented on the screen may not include a login button (e.g., or alternatively it may include an inactive (e.g., displayed in grey color) login button). In this case, after the user may approach a Ntag in which a username corresponding to a user account within said account server is stored, to a/the NFC reader integrated within the main device 1001 such that the NFC reader can read/scan said username. After reading/scanning the username, the main device 1001 may (e.g., preferably, automatically) send the username to the account server 1009. After receiving the username from the main device 1001, (e.g., only) if the received username matches a (e.g., a corresponding) username available/registered in the/a corresponding accounts database within the account server, then the account server may present a/the login webpage including the/a (e.g., an active) login button (e.g., such as that of FIG. 8A. In case of the inactive grey login button, the button becomes active and preferably it changes to another color) (e.g., and preferably, some other information so that the user is assured that he has provided a desired/correct username through the Ntag). At this time, the user may press the login button (e.g., confirming the/a request for login) and the account server may proceed to the/a corresponding authentication (e.g., circuit) procedure of the invention (e.g., as described before throughout this patent application (e.g., in regard to the exemplary FIG. 6A)). For more security, preferably, the login page of an application (e.g., herein may be referred to as “secured application”) of an account server (e.g., for accessing a user's account through a mobile device such as a smartphone) has preferably an interface requiring the entry of a username (e.g., only) through a Ntag. In this case, the access to said account by entering manually (e.g., by typing and/or copy and paste) a username and/or a password may be possible only by using a software other than said application. Optionally, a user may be given the opportunity to decide that his/her account can be accessed only by entering the username and the password, unless using said secured application (e.g., through the user's main device only).

A username for a user's account in an account server of a sensitive organization such as a bank is preferably assigned by said organization. As such, preferably, a Ntag including a/the (e.g., pre-installed) username/user-identification/user-unique-ID is preferably provided (e.g., physically (e.g., by courier/mail)) by said organization to the user.

An account-registration (e.g., sign-in) (e.g., web) page for creating an (e.g., a less sensitive) account (e.g., in an online shopping store) within an account server may require that a user defines and enters/provides a username (e.g., which thereafter during future login procedure within the created account will be required/used). In this case, preferably, when the username is defined and entered by a user, according to one method, said username may automatically be stored within a Ntag used-by/of a user. As such, after entering the username during the registration, the user may approach the Ntag to the NFC writer chip integrated within the corresponding (e.g., main) device such that a NFC communication is established between the NFC writer chip and the Ntag and as such the NFC writer writes/stores said username within the Ntag.

According to one embodiment, a request message (e.g., in-form-of/having a link) for authorizing execution of a function (e.g., such as paying an invoice, transferring money from a user's account to a third party, authorizing a task, etc.) (e.g., in favor-of/related-to a third party) may be sent, by an account server in which a user has an account, to the user's main device (e.g., which is part of a predefined authentication circuit). In response to the request (e.g., by pressing the link) a corresponding webpage of the account server may be opened on the user's main device, preferably displaying some information regarding the request and requiring the entry of the username of the user's account. After entering the username (e.g., by the user) an authentication procedure of the invention may be executed, after which, said authorization for execution of said function is considered to have given by the user.

By creating an authentication circuit/system that includes several (e.g., at least, three) devices/components that a user is used-to and/or can-easily carry and/or control such as, a first (e.g., main) device (e.g., a smartphone, a PC, a tablet, etc.), a second (e.g., an intermediate) device (e.g. a wearable device such as a smartwatch, a smart wristband, etc.) and a Ntag (e.g., attached-to/integrated-within/a wearable-object/user's-body, etc.) combined with the principles of the authentication methods/systems of the invention, a highly secured extremely easy authentication system may be created (e.g., practically eliminating the necessity of using a password) for accessing an (e.g., a password) protected account within an account server). If any (e.g., at least one) of the (e.g., mentioned) several devices/components is lost, stolen, or is not available during an authentication session/procedure of the invention, the authentication procedure cannot be accomplished. As an example, if a user desired to go for swimming in the sea, he/she can confidently leave his smartphone and his smartwatch on the beach but carry the Ntag with him/her (e.g., Ntag being attached/stick to his skin, swimming suit, etc.) in the sea (e.g., water). In this case, even if, both, the smartphone and smartwatch are stolen, they cannot be used for a successful authentication procedure. Note that, preferably, after transmitting the username to a the/corresponding server, the username may/will not be memorized on the user's corresponding (e.g., main) device (e.g., the username will (e.g., permanently) be deleted/erased from any and all memory/memories of the device.

Note that a Ntag does not lose the/a memorized data in contact with water. For more security, a Ntag can be protected by a water-resistance material (e.g., plastic cover) such that its/the memorized data still can be read/accessed/scanned.

Note that accessing a (e.g., login) webpage of a website/account server may be made by any known type of accessing a website such as by typing a URL, tapping on a corresponding link, tapping on a corresponding icon of an (e.g., a preinstalled or downloaded) application icon displayed on the (e.g., desktop) of a device (e.g., such as a smartphone, a tablet, a smartwatch), etc. Such accessing action, may herein be referred to as “accessing a login page of an account”.

Note that by using a Ntag for entering a username, a user does not have to remember a corresponding username for logging into an account within an account server. In addition, user preferably does not (e.g., need to) authorize the device to remember/save said username.

According to one embodiment of the invention, a card (e.g., preferably having a credit card form and/or size) in which a Ntag with a username is memorized may be used for accessing a user's account through/within an automated teller machine (e.g., herein may be referred to as “ATM machine”.

According to one aspect, said card may be a credit/debit card of the user and said username may be (e.g., at least) the credit/debit card number of the user.

According to one embodiment of the invention, without the need to remembering the pin number of his/her credit/debit card, a user using the authentication system of the invention may be enabled to securely enter/access into his account through/within an ATM machine and provide a (e.g., any and all) corresponding/desired function (e.g., withdrawal/deposit of money, etc.). FIG. 8C shows as an example, an ATM device 1129 used with the authentication system of the invention to enable a user to access his/her account (e.g., for withdrawing money).

In this example, (e.g., preferably, after accessing 7001 a/the login page of a corresponding (e.g., his/her bank/ATM) account server 1009 (e.g., by tapping on a corresponding app icon on his smartphone) on the main device 1001) the/a user may insert a corresponding (e.g., credit/debit) card 1113 (e.g., Note that, for simplicity of explanation, in this example we assume that the card is user's credit/debit card and the username is the credit/debit card number memorized/stored in a memory (e.g., a Ntag/chip) integrated within the card. It is understood, that said card may be another type of card having a Ntag in which a corresponding predefined username is stored) within the ATM machine 1129 and (e.g., if required) opt-for/select an authentication procedure without the pin on an interface of the ATM machine (e.g., by pressing a corresponding button on a corresponding/an interface displayed on the ATM 1129. Thereafter, the ATM machine may transmit 7011 the memorized username (e.g., in this example, the credit card number) to the corresponding account server 1009 (e.g., of the user's bank, of a corresponding financial company, of the ATM machine, etc.). Thereafter, the account server 1009 (e.g., or a related (e.g., online) entity) may proceed to an authentication procedure of the invention as described throughout this patent application. As an example, the server 1009 may send 7002 an encrypted security code to the/an intermediate device 1002 (e.g., a corresponding smartwatch). The account server 1009 may also send 7003 the corresponding decryption key (e.g., the key with which the corresponding code was encrypted) to the main device 1001 (e.g., a/the corresponding smartphone). After contacting, by the intermediate device 1002, a corresponding controlling server and identifying a corresponding transmission permission approval, the intermediate device may transmit 7004 the encrypted security code to the main device 1001, preferably through a NFC procedure. Then, after the encrypted code is decrypted on the main device 1001, the decrypted code may be displayed on the screen of the main device 1001. Thereafter, the user may type the decrypted code in a corresponding text field 1051 presented on the screen of the main device. Thereafter, the typed code is transmitted 7005 (e.g., by pressing a send key) to the account server 1009. After successfully authenticating the user (e.g., the user's device) the account server 1009 may inform 7012 (e.g., by transmitting a message) the ATM machine accordingly and permit the access to the user's account through/within the ATM machine. Optionally, the account server may also give access 7006 to a corresponding user's account in the account server. Thereafter, some of the ATM services may be provided/controlled through the main device. In this case, the user may be enabled to interact, on the main device on the ATM machine ot through a third device, with the account server 1009 for accessing/executing said services.

(e.g., In the current example, (e.g. and in any and all of other examples)), according to one aspect, the login page of the account server 1009 may automatically be opened on the screen of the main device 1001, after the credit/debit card is inserted with the ATM machine, and thereafter the corresponding identification number (e.g., username, credit/debit card number, etc.) is preferably transmitted 7011 by the ATM machine to the account server 1009.

It is understood that in the current example in a (e.g., any of other examples) of the authentication procedure of the invention, after transmission of the encrypted security code and the corresponding decryption key to the corresponding devices, optionally, after identifying a corresponding transmission permission approval by accessing a/the corresponding controlling account (e.g., by any of main device or the intermediate device) within the/a controlling server), the decryption code may be transmitted from the intermediate device to the main device. Thereafter, preferably, the rest of authentication procedure may be executed as per example of FIG. 6M.

Note that in the current example, optionally, the user may first insert the card into the ATM machine and then open/run the corresponding application on his/her main device. In this case, after opening the application, a corresponding interface (e.g., a login webpage) of the application will preferably be displayed on the screen of the main device. Preferably, in both cases, the corresponding decryption code is transmitted to the main device (e.g., preferably, after the corresponding application is opened on the main device). Optionally, after inserting the card into the ATM, and transmission of the username to the corresponding account server, the account server causes the corresponding application to be automatically opened on the main device.

Note that in the current example, the/an Ntag having the corresponding username may be integrated-within/attached-to the body of the main device. In this case, the use of a (e.g., credit/debit) card may not be necessary. In this case, as shown in exemplary FIG. 8D, the user may approach the main device 1001 to a reader component integrated within the ATM machine 1129 so that the username memorized in the Ntag is read 70011 by the reader, and thereafter, transmitted 7011 by the ATM machine 1129 to the account server 1009. The rest of the authentication procedure may be similar to that of FIG. 8C.

Optionally a username may be a unique identification number of a main device such as a serial number of the main device 1001. Optionally, instead of using a Ntag, a serial number of the main device may be defined transmitted, as a username, to a corresponding account server during a sign-in procedure for creating an account within the account server. Said username may be used during a login (e.g., and thereafter an authentication) procedure of the invention.

As mentioned before, an authentication system of the invention may be used for executing an action/function. As an example, a user may access a webpage for changing/replacing a current password by a new password.

According to one aspect, instead of using a Ntag, other means (e.g., a barcode/QR code/data matrix/etc.) for storing/representing a unique username may be used. Said other means may be used to provide (e.g., through a corresponding (e.g., barcode) reader installed in the main (e.g., optionally, in the intermediate)) said username (e.g., to a corresponding account server during a sign-in procedure and/or during a login procedure).

According to a preferred method, a single username may be assigned to several accounts each created within a different account server. Accordingly, as an example, a single Ntag having said username may be used to provide a/the username during a login procedure within each if said several accounts. As an example, a Ntag having a username may be used for logging into a user's first account within a first bank server, and the same Ntag may be used for logging into a user's second account within a second bank server.

Note that a single authentication circuit (e.g., a main device, an intermediate device and a controlling account within a controlling account server) is preferably/generally used for accessing to a plurality accounts within different account servers.

According to one embodiment of the invention, an authentication system of the invention may enable a user to use any main device with the authentication system of the invention. In this case, preferably, use of a Ntag for entering a username may be required. As an example and by referring to exemplary FIG. 8E, after opening a login webpage, of an application corresponding to an account server, on his/her main device 1001 (e.g., a smartphone), a user (e.g., owner of an account within said account server) may use the main device 1001 for entering his/her username memorized/stored in a Ntag (e.g., herein integrated with a card 1003) through a NFC reader 8200 integrated-within/of the main device 1001 by approaching the Ntag 1003 and the main device 1001 such that a short range communication (e.g., NFC process) is established between said main device and the Ntag so that the username is scanned/read by the NFC reader 8200 of the main device 1001. Thereafter, the main device 1001 may transmit 8201 the username to the corresponding account server 1009. Thereafter, the account server 1009 may send/transmit 8202 an encrypted security code to a corresponding intermediate device 1002 and also transmit 8203 a corresponding decryption key to the main device 1001. (e.g., Preferably, after identifying a corresponding transmission permission approval from the controlling sever to transmit the security code to a (e.g., a random/any) next device), the encrypted security code is transmitted (e.g., either sent 82061 by the intermediated device 1002 to the main device 1001, or is retrieved 82062 by the main device 1001 from intermediate device 1002) from the intermediate device 1002 to the main device 1001, preferably, through a short-range communication system (e.g., a NFC system). After being decrypted (e.g., in the main device 1001) using the decryption key, the decrypted code may be (e.g., typed in a corresponding text field by a user and) transmitted 8207 to the account server 1009. After approval of successful authentication procedure, the account server 1009 may enable the access of a/the corresponding account to the user.

In the current embodiment, an identification information (e.g., serial number) 8011 of a/the main device is not required by the controlling account 8010 but because the user controls a medium/card having a Ntag 1003 including the username of the account and also controls the intermediate device (e.g., a smartwatch) 1002, the authentication system of the invention is still highly secured (e.g., even if the user uses a random main device which is not registered in the controlling account 8010). As an example, if a one of, the Ntag and the intermediate device, is lost/stolen, the third entity controlling the lost/stolen Ntag or the lost/stolen intermediate device will not be able to enter into the user account with a his/her (e.g., any) main device.

Nevertheless, it is recommended that the current authentication system/embodiment to be used for logging into low-sensitive accounts. Note that in the current embodiment, the login interface may preferably do not permit to enter a username other than through/by-means-of a (e.g., passive) Ntag/chip (e.g., the interface of a corresponding login page may preferably do not include a text field for entering a username).

According to one embodiment, a credit/debit card number may be defined and used as an identification information of a user's account within an account server. According to one embodiment of the invention, in order to access to his/her account through/within a ATM, a/the user may insert his/her/the credit/debit card into the ATM. Thereafter, the ATM will transmit the credit/debit card number to a corresponding account server which thereafter identifies a corresponding login information such as a telephone number of the owner of the account, Thereafter, a/the corresponding account server may send/transmit (e.g., by SMS) a (e.g., an unencrypted) (one-time and/or random) security code to the/a corresponding device (e.g., a smartphone) of the owner of the account within said account server. After receiving said security code on his/her said device, the user/owner may be enabled (e.g., by pressing on a link received from the account server by SMS) by a corresponding software related to the account server running within the device to enter said security code within a corresponding text field and cause (e.g., by pressing a “send” key) the device to transmit the entered code to the corresponding account server. After receiving said code from the main device, by the account server, and successful authentication, the user may be given access to his/her account within/through the ATM. Note that in the current embodiment, the authentication procedure preferably may/does not use an intermediate device.

According to one aspect of the invention, an account within an account server may have more than one usernames, wherein one of the usernames may be a credit/debit card number of a corresponding owner of the account.

According to one embodiment of the invention, a NFC means such as a NFC tag (e.g., or alternatively, the NFC chip) used with the authentication circuit of the invention may be implemented within a wristband/bracelet of the smartwatch. Alternatively, said NFC tag may be located on another location attached to or integrated within the body (e.g., under skin) of a user using the authentication circuit of the invention.

According to one embodiment, for more security, an additional NFC tag may be attached to a wearable object and used with the authentication circuit of the invention.

It must be noted that any communication device (e.g., having a processor and an operating system such as a desktop, a laptop, a tablet, a smartphone, a smartwatch, etc.) may be used as the main device, an intermediate device or as additional intermediate device. (e.g., Note that, a processor of a device is used for processing at least some (e.g., optionally/preferably, all) of the software (e.g., applications) running within said device). A device may have one or more processors.

According to one aspect, if (e.g., for any reason) the controlling application of the invention is not available on a device of the authentication circuit, said device may use an alternative controlling application for receiving a message from and/or sending a message to another device of the authentication circuit.

Note that a contact information of a device, used by a corresponding authentication system, can/may be any kind such as a telephone number, an email, an IP address, etc.

Note that, if an authentication circuit has more than one intermediate device, then the descriptions regarding procedures of redirecting a (e.g., an encrypted) code, by an intermediate device, to the main device, is preferably referred to the last intermediate device within said authentication circuit.

According to one aspect, the controlling application running within a device within an authentication circuit receiving a security code from another device, may preferably check (e.g. by-using/through a corresponding controlling account) the authenticity of the identification number of said another device in accordance with the corresponding parameter stored within (e.g., a memory such as a table of) said controlling account.

According to one embodiment, the order of sending an encrypted code and the corresponding decrypting key may be reversed. As an example, in an authentication procedure, the account server may send the encrypted security code to the main device. In this case, the account server preferably may send the decryption key to the intermediate device. After identifying the main device by the intermediate device, the decryption key may be send from the intermediate device to the main device. Thereafter, the encrypted key may preferably be decrypted in the main device.

It must be noted that the decryption procedure may be executed within any of the devices of an authentication circuit. As an example, after identifying the main device by the intermediate device, the decryption key may be send from the main device to the intermediate device. Thereafter, the encrypted key may be decrypted in the intermediate device and preferably thereafter the decrypted code may be sent to the main device and from there to the account server (e.g., or optionally, to another device such as the main device and from there to the account server). Note that, within a/the authentication circuit (e.g., of the invention), a device (e.g., an/the intermediate device) used for an/the identification procedure (e.g., of the main device) and/or in charge of transmitting a/the received encrypted security code to a/the main device may herein be referred to as “controlling device”.

Note that the decryption procedure may be executed within any device (e.g., including the controlling server) of and/or related to the authentication circuit

The authentication system described in this patent application has the advantage of not requiring a password for accessing a desired protected account in a server. This system also eliminates the burden of carrying a list of passwords by a user for accessing a/the desired protected account, and also eliminates/reduces the risk related/caused-by the passwords being lost, hacked or stolen. The authentication system described herein is highly secured because the controlling server has no access to an encrypted and/or a corresponding decrypted security code, the intermediate device has no access to the decrypted code, and the main device has no access to the encrypted security code until is transferred to the main device from a few centimeters distance.

It is understood, that, if/when desired, a user can access his/her/a desired protected account in a traditional manner log in procedure by using (e.g., at least) an identification information (e.g., an email) and a password.

Note that, for simplification, some terms used throughout this patent application may have been abbreviated/shortened. As an example,
“within an account server”, may preferably mean, “within and/or controlled-by an account server”
“a user”, may preferably mean, “a user controlling a (corresponding) device”
etc.

Note that security code may be a reference (e.g., a URL) to a security code, In this case, after said reference is received by a predefined device of an authentication circuit, said device may access to/download and use (e.g., send to a next/following device, decrypt it, etc.) said security code.

It must be noted that the embodiments, methods, systems, features, functions, etc., in this patents application are used as examples to describe the principles of the authentication circuit/system of the invention. Other embodiments, methods, systems, features, functions, etc., may be considered and used by people skilled in the art based on the principles of the authentication circuit/system of the invention. As an example, after a login request is sent to an account server from a main device, the account server may send an encrypted security code to the main device and the corresponding decryption key to the/a (e.g., corresponding) intermediate device.

Also as an example, instead of sending an/the encrypted security code (e.g., or alternatively, the decryption key) from the intermediate device to the main device, a/the corresponding decryption key (e.g., or alternatively, the corresponding encrypted security code) may be sent from the main device to the intermediate device.

Note that the decryption procedure of the encrypted security code using the decryption key may be processed within one (e.g., any) of, the/a main device and the/an intermediate device.

According to one principle, if transmitting of an encrypted security code (e.g., or alternatively, a corresponding decryption key) from a first device to a second device within the authentication circuit of the invention is defined to be authorized, it is understood that such transmission of the encrypted code may be on one of the following ways/methods:
a) The encrypted security code may be sent from the first device to the second device; or
b) The encrypted security code may be retrieved from the second device by the second device.

As an example, in FIG. 6A, instead of sending 1006, by the intermediate device 1002, the/a received encrypted security code to the main device 1001, the main device 1001 may retrieve the encrypted security code from the intermediate device 1002 through a short range communication system (e.g., a NFC system) as defined/shown by parameter 6202 and authorized by parameter 6203 in the parameter table 6010.

Note that, the term “security code” used in this patent application, preferably, may mean/refer-to a random code preferably created by/within by a software (e.g. within/by an account server), and preferably being encrypted, by an encrypting software (e.g., within/by said account server), using an encryption key. This matter is known by people skilled in the art. Accordingly, the term “decryption/decrypting code/key” used in this patent application, may preferably mean/refer-to said/the encryption key used for encrypting said security code.

Note that for further security purpose, in addition to a Ntag used for entering a username, at least one (e.g., an additional) Ntag having unique code/data, stored within the Ntag's memory space, may be used as an additional device/component with the authentication circuit devices of the invention.

As an example, and by referring to the exemplary FIG. 8F, during a/the handshake procedure for creating a controlling-account/authentication-circuit, in addition to the identification numbers of the/a main device and the/an intermediate device, a (e.g., predefined) identification information (e.g., herein may be referred to as “tag-ID” or “Ntag ID”) stored within a Ntag (e.g., implemented in an object as described before) of a user may be transmitted-to/retrieved-by (e.g., a NFC reader of a user's device) to a/the corresponding controlling account within a/the corresponding circuit controlling server (e.g., and stored in a corresponding field 8111 in a corresponding table 8110 of the controlling account). As such, as an example during an authentication procedure, a/the user may be required, by the controlling account/server, to enter/provide/transmit said predefined tag-ID (e.g., by scanning said Ntag by the/a corresponding main/intermediate device and transmitting it) to the controlling account for identification purpose. In the current embodiment, for the authentication system to approve the authentication procedure as successful, in addition to matching the decrypted security code with the original security code, the provided tag-ID during authentication procedure must also match the Ntag ID 8111 stored in the corresponding (e.g., table of the) controlling account.

It is understood that instead of a Ntag a (e.g., one or more) other means (e.g., a barcode/QR code/data matrix/etc.) storing/representing a/said unique identification information may be used for the same purpose.

According to one embodiment, if an attempt to login within an account server is not successfully accomplished, the corresponding account server and/or the corresponding controlling server inform/s at least one, preferably all, of the device/s of the corresponding authentication circuit (e.g., or to another predefined device assigned/dedicated for such information).

According to one embodiment, a means such as a button within an interface of an application (e.g., of/related-to a/the controlling application of a corresponding controlling circuit) is dedicated/adapted-to pause or cancel an (e.g., a corresponding) authentication circuit upon an interaction-with (e.g., pressing) said means/button. As an example, the/an authentication circuit/system of the invention may include an application (e.g., herein may be referred to as a “circuit deactivation application”) related to said authentication system adapted to be installed (e.g., by an admin/owner of an authentication circuit controlling account) within at least one device of a corresponding authentication circuit and/or within a device other than a device of the authentication circuit (e.g., within a laptop, a tablet, another smartphone which is not part of the authentication circuit). By (e.g., opening said deactivation application and) providing a predefined interaction with said circuit deactivation application (e.g., by pressing a predefined button of an interface of said circuit deactivation application) a corresponding authentication circuit (e.g., account) may become deactivated/canceled (e.g., ay become none functional). As an example, by pressing a predefined button of said circuit deactivation application, a corresponding intermediate device of a corresponding authentication circuit may become unauthorized to transmit the/any/all encrypted security code/s, received by said intermediate device, to a/the corresponding main device (e.g., by switching the corresponding parameter in the corresponding table of the controlling application/server as described) from “active” to “pause”). Optionally (e.g., but not preferably) said circuit deactivation application may optionally have an additional means for reactivating (e.g., by the user) the corresponding authentication circuit. Note that for such purpose, (e.g., for each authentication circuit (e.g., account)) the circuit deactivation application may preferably have access to a corresponding controlling account within a corresponding controlling server (e.g., without requiring an (e.g., any) identification information (such as a username and/or a password)). Note that the deactivation application may run independently from the (e.g., a corresponding) authentication system of the invention.

It must be noted that throughout this patent application, terms such as “short range communication system”, “NFC” and “near field communication system” are used. It is understood that a short range communication system may be meant-to-be/considered-as NFC system, and vise versa. According to one aspect that after a predefined number of (e.g., three) times, requests for logging into a user's account is provided by a user and a security code is sent each of said number of times to a corresponding intermediate device but said security codes are not transmitted to the main device by the intermediate device, the login procedure into said account may be suspended for at least a predefined laps of time.

Using a smartphone and a wearable device (e.g., a smartwatch) (e.g., as respectively, the main device and the intermediate device of an authentication circuit) may be very beneficial because the user does not have to carry two non-wearable devices such as two handsets (e.g. two smartphones). This may even help to promote wearable devices as they may will become very useful.

According to one method, if a user receives a (e.g. an encrypted) security code by/into his device from an account server without having started a corresponding log-in procedure, then, the user may assume that the corresponding (e.g. his/her) main device may be stolen and/or is being used without the user's consent. In this case, the user may disable/remove the main device from the corresponding authentication circuit.

According to one aspect, the cancelation/removal may be ordered by providing a predefined interaction (e.g., such as pressing a corresponding button) on the intermediate device. The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

Thus, while there have been shown and described and pointed out fundamental novel features of the invention as applied to alternative embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto. It is to be understood that the drawings are not necessarily drawn to scale, but that they are merely conceptual in nature. It must be noted, that any of the embodiments, systems, features, means, methods, etc., described in this patent application may be used separately or being combined with any other one or more of other systems, features, means, methods, etc., of described in this patent application. Note that, in order avoid cumbersomeness, in some embodiments described in this patent application referred to corresponding Figures in the drawings, some functions/procedures/activities may have not been repeated (e.g., herein may be referred to as “purposely omitted features”) in the specifications and/or in the drawings but have been explained and/or shown in other embodiments. It is understood, that such purposely omitted features are considered to be included in said some embodiments. As an example, in some of the drawings, the arrow showing the transmission of a corresponding decryption key from an account server to a (e.g., main) device of the authentication system of the invention may have not been shown but it is understood that when an encrypted security code is sent/transmitted to a first (e.g., main) device by an account server, a decryption key is also sent/transmitted to a second (e.g., intermediate) device (e.g., by said controlling server).

Examples of embodiments, systems, methods, aspects, and other explanation written thought the specification of this patent application and the corresponding examples of drawings, are used/brought to describe the gist of the invention. it is understood that various examples of embodiments, systems, methods, aspects, and other explanation may be provided/bring-out by those skilled in the art without departing from the spirit of the invention.

In this application the terms “log in”, “login”, “log-in” have preferably the same meaning. Also, the terms “sign in”, “signin”, “sign-in” have preferably the same meaning.

In some embodiments/portions of the current patent application, the intermediate device is described to send the (e.g., encrypted) security code to the main device through a short-range communication system.

In is understood that any type of communication technology may be used for transmission of the security code form the intermediate device to the main device (e.g., or vise versa). For example, the security code may be intercepted/retrieved/cached by the main device from the intermediate device. As an example, after receiving a security code by the intermediate device from the/an account server, the security code may be written in a Ntag integrated within the intermediate device by for example a controlling application of the system. Then, said security code may be retrieved by a NFC reader of the main device from the intermediate device when the two devices are approached to each other such that the Ntag becomes in the range of the communication range of the NFC reader of the main device. The current principles may replace/be-applied-to all of transmission procedure of the security code from the intermediate device to the main device in said (e.g., and other) embodiments/portions of the current patent application.

In some portions of this patent application, a term such as sending a permission request and/or getting permission/authorization (e.g., by an intermediate device) from the controlling server have been mentioned. It must be noted that in general, these term are to be interpreted as to accessing the controlling account and verifying the transmission/transfer authorization status/parameter of the corresponding (e.g. intermediate) device to find out whether (e.g., or not) the device is permitted to transmit/transfer the (e.g., encrypted) security code to a next (e.g., main) device (e.g., and some other conditions/information such as the unique ID number of the (e.g., main) device to which the security code is permitted to be transmitted, under which condition (e.g., short range transmission/transfer, long-range transmission/transfer, etc.).

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

The above explains several embodiments with reference to the drawings. Each embodiment may have a portion corresponding to that of a precedent embodiment; such a portion is assigned with an identical reference number so as to omit overlapped explanation. When only a portion of the configuration of each embodiment is explained, the other portions of the configuration may adopt those of the precedent embodiment previously explained. Partial combination between the embodiments may be possible with respect to not only a portion which is explicitly described in each embodiment, but also a portion which is not explicitly described. Not for simplicity purpose (e.g., for not repeating the entire procedure of the/an authentication system of the invention), in some se of embodiments, the complete procedure of the authentication system of the invention may have not repeated.

1. An authentication system comprising:
an account within an account server, said account being protected by a login procedure;
a first communication device,
at least a second communication device; and
a controlling server controlling a communication between the first device and the second device;
wherein upon receiving, by the account server, a login request from the first device for accessing said account: (a) an encrypted random code is transmitted, from the account server, to the second device, and (b) a corresponding decryption key is transmitted by the account server to the first device;
wherein upon receiving said encrypted code from the second device and getting authorization, from the controlling server, for transmitting the encrypted code from the second device to the first device, the encrypted code is transmitted from the second device to the first device; and
wherein upon receiving, by the first device, the encrypted code from the second device, the encrypted code is decrypted using said decryption key; and
wherein the authentication system further includes a memory medium, separately from the first and the second devices, wherein said medium includes a username required during the login procedure.

2. The system of claim 1, wherein the decrypted code is transmitted from the first device to the account server and wherein upon receiving said decrypted code, by the account server, an access to said account is given to said first device.

3. The system of claim 1, wherein the encrypted code is decrypted within the first device.

4. The system of claim 1, wherein the decrypted code is automatically transmitted to the account server from the first device.

5. The system of claim 1, wherein the decrypted code is presented by the first device to a user and wherein after entering, by said user, the decrypted code into the first device, the decrypted code is transmitted, from the first device, to the account server.

6. The system of claim 1, wherein said username is transmitted to the first device through a near field communication system, and wherein thereafter the username is transmitted from the first device to the account server.

7. The system of claim 1, wherein the encrypted code is transmitted to the second device through a messaging application.

8. The system of claim 1, wherein the decryption key is transmitted to the first device through a messaging application.

9. The system of claim 1, wherein the encrypted code is transmitted from the second device to the first device through a short-range communication technology.

10. The system of claim 1, wherein the encrypted code is transmitted from the second device to the first device through a near-field communication system.

11. The system of claim 1, wherein upon receiving the encrypted code from the account server, the encrypted code is transmitted from the second device to the first device through a communication technology defined within the controlling server.

12. The system of claim 1, wherein the controlling server includes an account having at least one parameter for controlling a communication between the second device and the first device.

13. The system of claim 1, wherein at least one of, a contact information of the first device, a contact information of the second device, a username and a password are provided to the account server during a registration procedure for creating said account.

14. The system of claim 1, wherein said decryption key is transmitted to the first device through Internet.

15. The system of claim 1, wherein the encrypted code is transmitted, from the second device, to the first device through a near field communication technology and wherein a communication for transmitting the encrypted code from the second device to the first device is interrupted if a distance between said first device and the second device is more than a communication range of said near field communication technology.

16. The system of claim 1, wherein said account is used for executing a function.

17. The system of claim 21, wherein said function is opening a locked lock.

18. The system of claim 1, wherein said account server is an online server handling money transactions.

19. The system of claim 1, wherein the second device is a smartwatch.

20. The system of claim 1, wherein the first device is a smartphone.
